(19) United States
(12) Patent Application Publication
(10) Pub. No.: US 2010/0214223 A1
(43) Pub. Date: Aug. 26, 2010

(54) MOUSE WITH TWIST DETECTION MECHANISM

(75) Inventors: Rodney Jackson, Mancester (GB); Barry Marshall, Bispham (GB)

Correspondence Address: CONLEY ROSE, P.C.;David A. Rose, P. O. BOX 3267, HOUSTON, TX, 77253-3267, US

(73) Assignee: COJAC LIMITED, Manchester (GB)

(21) Appl. No.: 12/064,970

(22) PCT Filed: Aug. 24, 2006
(86) PCT No.: PCT/GB2006/003165

§ 371 Date: Feb. 27, 2008

(30) Foreign Application Priority Data
Aug. 27, 2005 (GB) 0517528.6

(51) Int. Cl. G06F 3/033

(52) U.S. Cl. 345/164

(57) ABSTRACT

A computer input apparatus, comprising: a base provided with a socket; a ball segment located in the socket and rotatable in the socket, the ball segment being shaped to support a wrist of a user; a handle attached to and extending away from the ball segment and configured such that when the user's wrist is supported by the ball segment, the handle is adjacent to the user's hand and maybe held by the user.

The present invention relates to a computer apparatus and in particular, to a computer input apparatus.

There are a wide variety of input apparatus for computers. For example, keyboards may be used to enter text into a computer program, whereas a mouse may be used to position a cursor and make selections in an on-screen menu system.

Many real-life and computer applications now require control in three dimensions. Such applications include the control of robots, three-dimensional drawing packages and games. Three-dimensional control has been realised in a number of ways. For instance, the control of a character in a three-dimensional gaming environment may be achieved using a combination of a mouse (to look around the three-dimensional environment and define a direction of movement) and a keyboard (to effect the movement). The mouse or keyboard could be replaced with a joystick or game-pad, both popular input devices for the control of computer games.

Consumer demands have resulted in computer input devices which attempt to offer accurate control, as well as a high degree of functionality. For example a three-dimensional positional device is disclosed in International Patent Application WO 98/35315. The device disclosed in this application comprises a casing which is connected to, and moveable relative to a non-moveable base plate. The device is able to detect movement in orthogonal x, y and z directions, where movement in the x or y directions is substantially parallel to a surface on which the device is used, and movement in the z direction is substantially perpendicular to the surface. Movement in the x, y or z directions corresponds to movement of the casing left and right, forwards and backwards, and up and down respectively. The device is configured to provide corresponding input signals to, for example, a computer. Input of movement signals in the x and y directions is realised by movement of the casing of the device in the x or y direction respectively. Input of movement signals in the z direction is realised by pivoting the casing of the device about the x-axis. The device uses the Hall Effect to detect movement of the casing, the movement being converted into an electrical signal that is then input into the computer.

Although the three-dimensional positional device of WO 98/35315 offers more functionality than, say, a standard mouse, it does have drawbacks, and also lacks the functionality demanded by consumers.

The three-dimensional positional device illustrated in WO 98/35315 is unable to twist, which is a desirable feature in, for example, gaming and computer aided design applications. The device also has an unsophisticated mechanism for returning the casing to an equilibrium position when no pressure is applied to the casing i.e. a position where no input or a zero input should be generated. Such a mechanism is known as a ‘return to zero’ mechanism. Due to the return to the zero mechanism's lack of sophistication, the casing is not always returned to an acceptable zero position. Thus, after removing pressure from the casing, the casing may still be generating an input signal in a given direction, even with no input from a user of the device. This is not acceptable in almost all fields of use.

The provision of a twist function in an input device is desirable in some applications. However, it is known that some people using a mouse tend to twist their hand as they move the mouse forward and backwards, or left and right. Such twisting diminishes the user's ability to accurately control forward and backwards, or left and right movement of the mouse and thus control, for example, the position of an element appearing on a computer screen.

It is thus an object of the present invention to obviate or mitigate at least one of the above-mentioned disadvantages.

According to a first aspect of the present invention, there is provided a computer input apparatus, comprising: a base provided with a socket; a ball segment located in the socket and rotatable in the socket, the ball segment being shaped to support a wrist of a user; a handle attached to and extending away from the ball segment and configured such that when the user's wrist is supported by the ball segment, the handle is adjacent to the user's hand and maybe held by the user.

According to a second aspect of the present invention, there is provided a computer input apparatus, comprising: a base, the base being provided with a socket; a ball segment located in the socket and rotatable in the socket, the ball segment being pivotable about a first axis, bankable about a second axis orthogonal to the first axis, and twistable about a third axis orthogonal to the first and second axis; and a twist detection mechanism for measuring twist of the ball about the third axis, the twist detection mechanism comprising a detector and a detectable element moveable relative to each another, one of the detector and the detectable element being slideably and rotatably connected to the ball segment, such that pivoting of the ball segment about the first axis or banking of the ball segment about the second axis does not affect the position of the detector or the detectable element, and such that twisting of the ball about the third axis does affect the position of one of the detector and the detectable element.

Preferably, the ball segment is provided with a guide, one of the detector and the detectable element being slideably connected to the ball via the guide.

Preferably, the guide comprises two prongs of a fork.

Preferably, one of the detector and the detectable element is slideably connected to the fork by a frame.

Preferably, a part of the frame extends between the prongs of the fork.

Preferably, a carrier is attached to the frame. Preferably, the carrier is rotatably attached to the frame.

Preferably, the detectable element is attached to the carrier. Preferably, the detector is fixed in position relative to the socket.

Alternatively, the detector is attached to the carrier. Preferably, the detectable element is fixed in position relative to the socket.

Preferably, the detector is a Hall Effect sensor and the detectable element is a magnet.

Preferably, the magnet is moveable relative to the Hall Effect sensor, and is slideably and rotatably connected to the ball segment. Alternatively, the Hall Effect sensor is moveable relative to the magnet, and is slideably and rotatably connected to the ball segment.

Preferably, the ball segment is shaped to support a wrist of a user.

Preferably, the ball segment is provided with a handle attached to and extending away from the ball segment and configured such that when the user's wrist is supported by the ball segment, the handle is adjacent to the user's hand and maybe held by the user.

Preferably, the distance between the ball and the handle is variable. Preferably, the socket is moveable relative to the base.

Preferably, the base comprises a planar base plate, and the socket is moveable in a plane substantially parallel to the planar base plate.

Preferably, the socket is formed in a section of a plate.

Preferably, the ball segment is substantially hemispherical in shape.

Preferably, the ball segment forms a concave surface for receiving the wrist of a user.

Preferably, the ball segment is provided with a cushioning element. Preferably, the cushioning element is a gel pad.

According to a third aspect of the present invention, there is provided a computer input apparatus comprising a casing, the casing being connected to, and moveable relative to a base; a post, attached to the casing, which extends towards the base; a return to zero mechanism for returning the position of the post and the casing to which it is attached to an equilibrium position when no pressure is applied to the casing, wherein the return to zero mechanism comprises a support structure defining an aperture through which the post extends; and a plurality of arms pivotably attached to the support structure, the plurality of arms extending into the aperture and being biased toward the centre of the aperture, the plurality of arms being arranged to return the position of the post, and casing to which it is attached, to a zero position.

A computer input device having a return to zero mechanism comprising pivotably mounted arms offers greater versatility, and ensures an accurate and consistent return to zero mechanism.

Preferably, adjacent arms extend into the aperture at different heights.

Preferably, the plurality of arms are substantially straight.

Preferably, the apparatus comprises at least a pair of arms, each arm of the pair being attached to an opposite side of the support structure. Preferably, the apparatus comprises four pairs of arms.

Preferably, the at least one arm is provided with an outer stop, arranged to restrict movement of the arm towards the centre of the aperture.

Preferably, the at least one arm is provided with an inner stop, arranged to restrict movement of the arm away from the centre of the aperture.

Preferably, the support structure is a ring.

Preferably, the at least one arm is biased by an O-ring.

According to a fourth aspect of the present invention, there is provided a computer input apparatus comprising a casing, the casing being connected to, and moveable relative to a base; and an anti-twist device for preventing twist of the casing relative to the base; and wherein the apparatus further comprises a clutch mechanism, comprising a first surface; a second surface; a biasing member arranged to bias the first surface away from contact with the second surface when no pressure is applied to the first surface; and wherein the clutch mechanism is arranged such that, when sufficient pressure is applied to the first surface to overcome the biasing member, the first surface contacts the second surface and disengages the anti-twist device, thereby allowing twist of the casing relative to the base.

By providing an apparatus that is able to twist or not twist depending on the engagement of the clutch mechanism, a single device can offer twist and non-twist functionalities.

Preferably, the anti-twist device is located between the casing and the base.

Preferably, the apparatus further comprises a twist plate connected to, and twistable relative to the base plate, and wherein the anti-twist device is attached to the casing and to the twist plate.

Preferably, the anti-twist device is pivotably attached to the casing and the twist plate. Preferably, the anti-twist device is a pantograph.

Preferably, a surface of the twist plate forms the second surface.

Preferably, the first surface is attached to the casing.

Preferably, at least one of the first surface and the second surface has a high coefficient of friction.

Preferably, at least one of the first surface and the second surface is annular.

Preferably, the biasing member is disposed between the first surface and second surface.

Preferably, the biasing member is one of a group comprising: a wavy washer and a coil spring.

Preferably, at least one of the first surface and the second surface comprises a recess.

Preferably, the recess is annular.

Preferably, the biasing member is located in the recess, and arranged to protrude from the recess when in an uncompressed state.

Embodiments of the present invention will now be described, by way of example only, with reference to the accompanying Figures, in which:

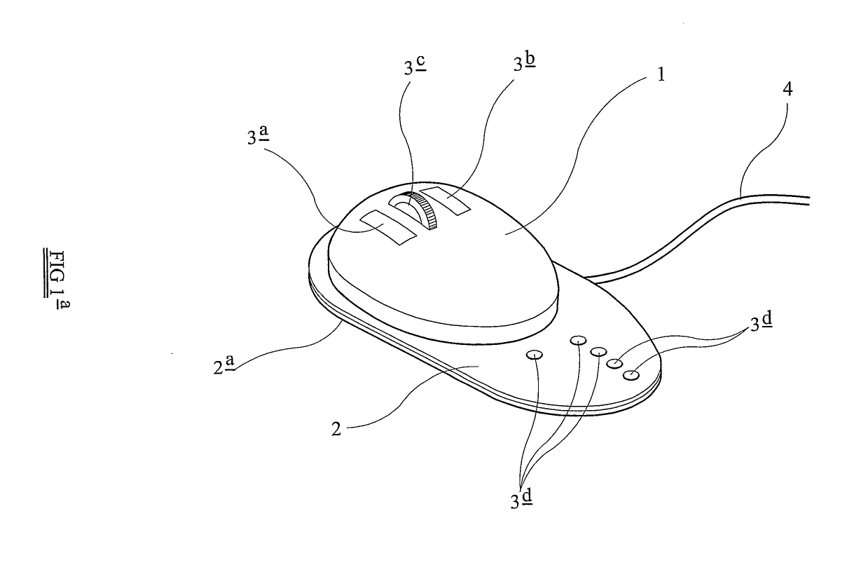

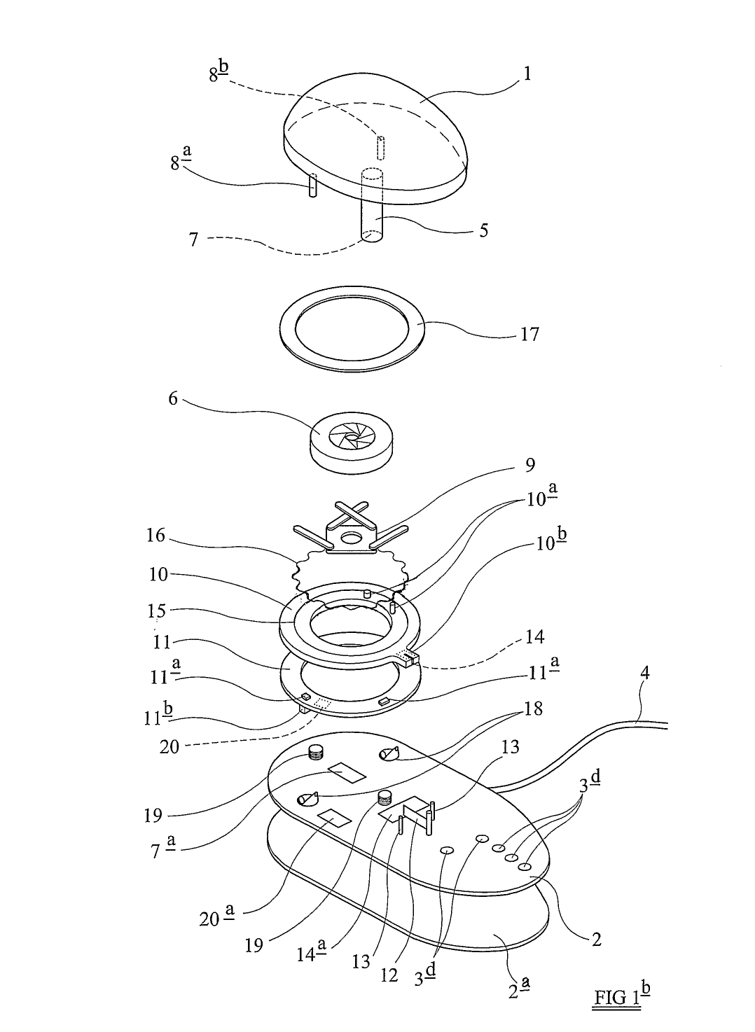

FIG. 1a is a perspective view of a computer input apparatus according to an embodiment of present invention;

FIG. 1b is an exploded view of the computer input apparatus of FIG. 1a;

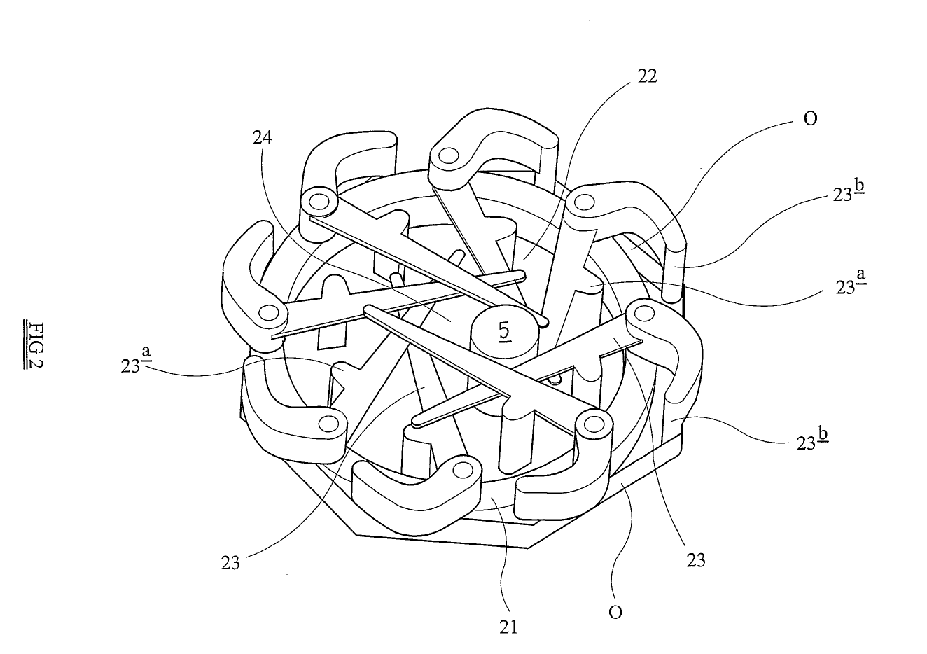

FIG. 2 is a perspective view of a return to zero mechanism according to an embodiment of the present invention;

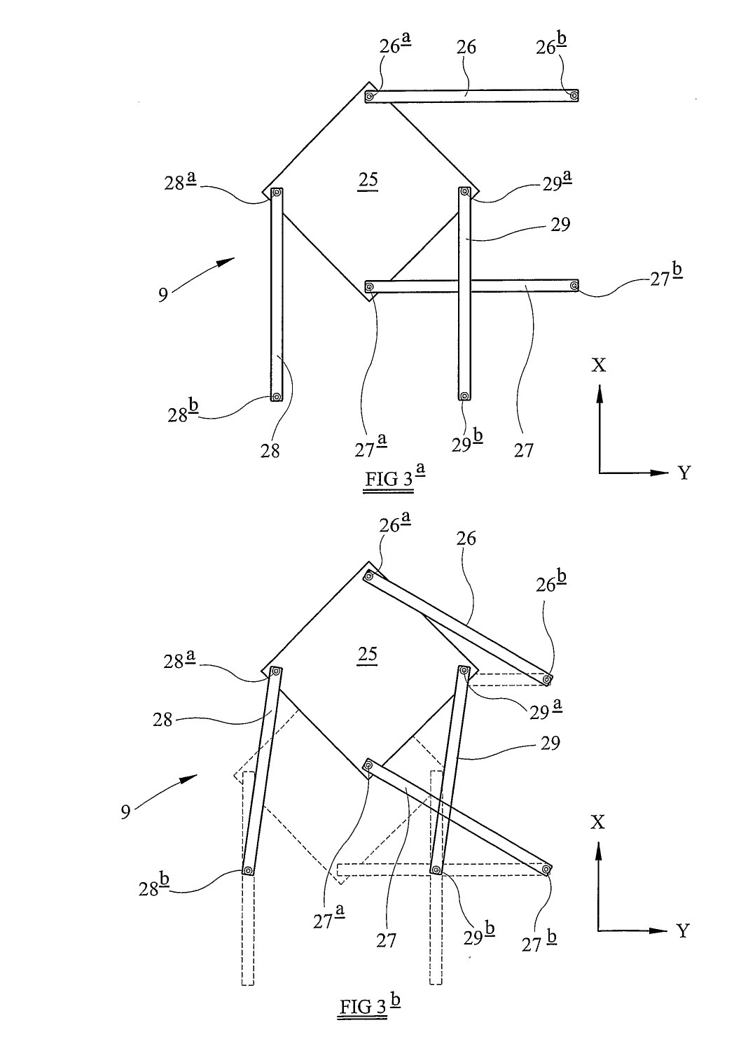

FIG. 3a and FIG. 3b are plan views of an anti-twist mechanism incorporated in the computer input apparatus of FIG. 1a;

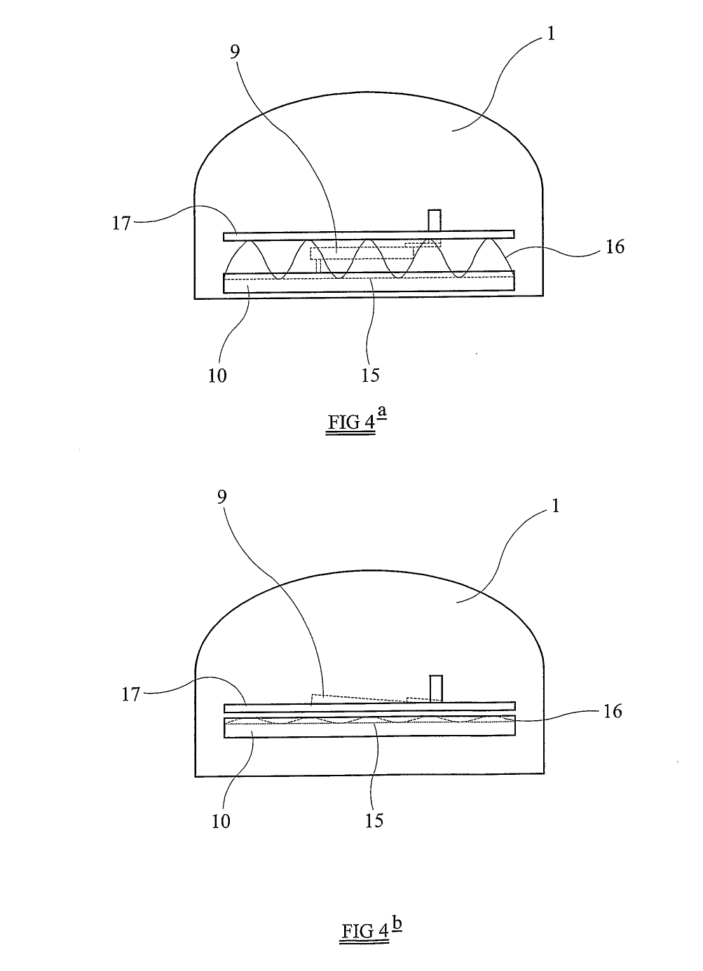

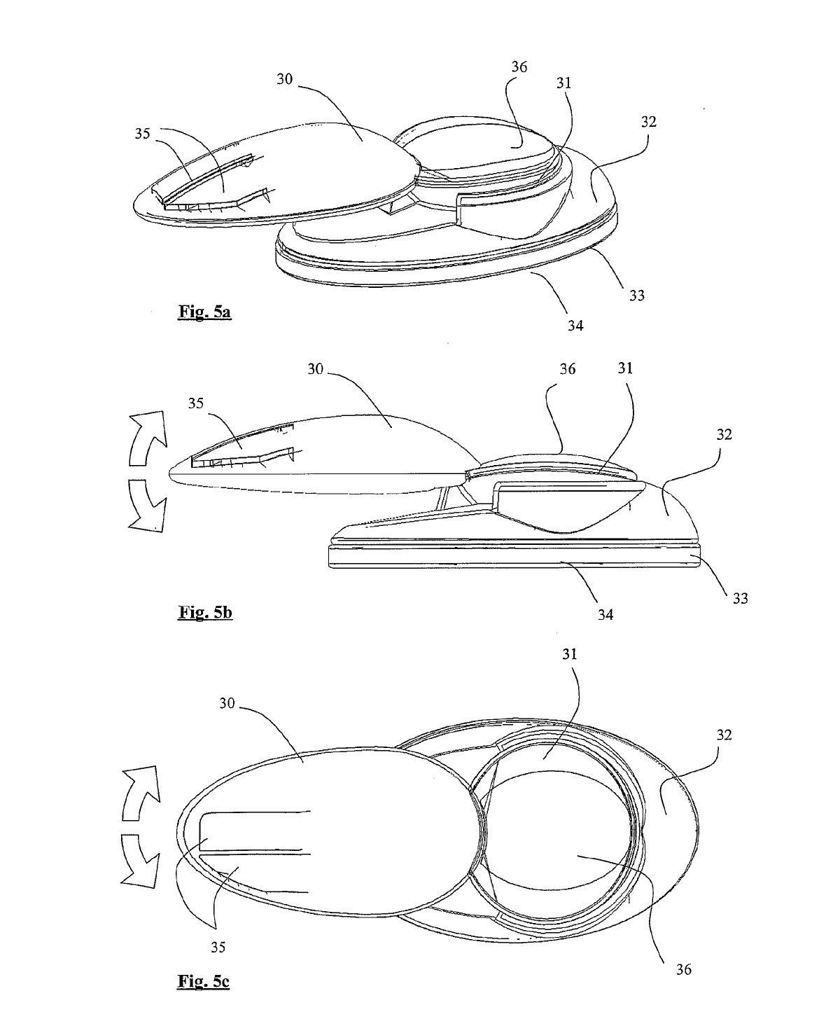

FIG. 4a and FIG. 4b are cross-section views illustrating a clutch mechanism according to an embodiment the present invention;

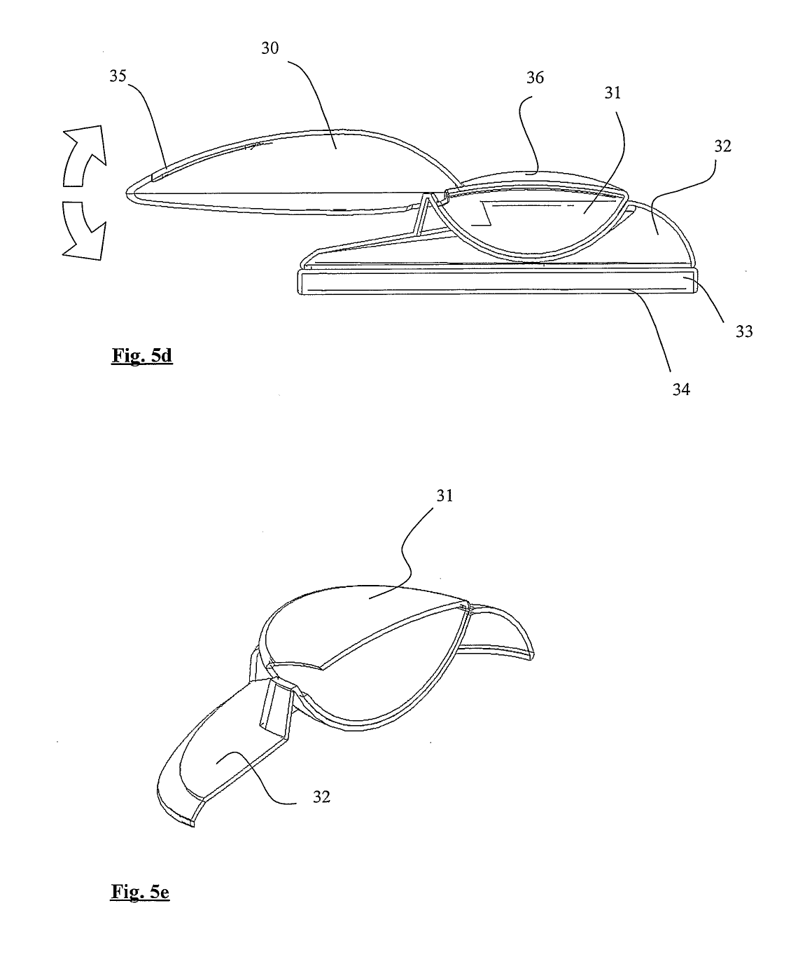

FIGS. 5a to 5e illustrate a computer input apparatus according to another embodiment of the present invention;

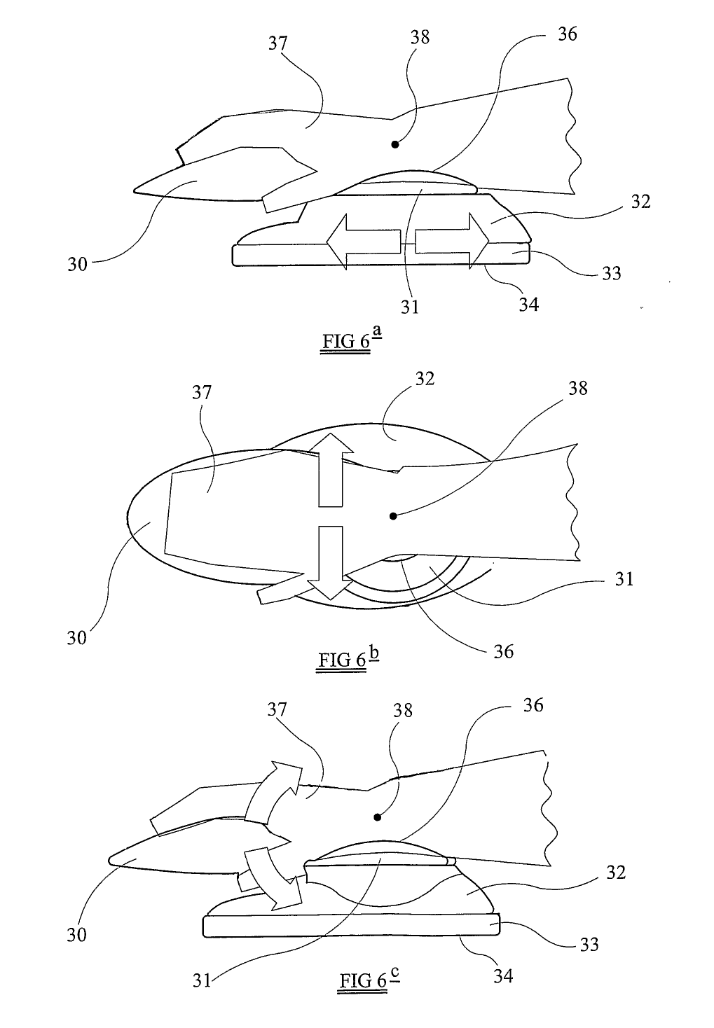

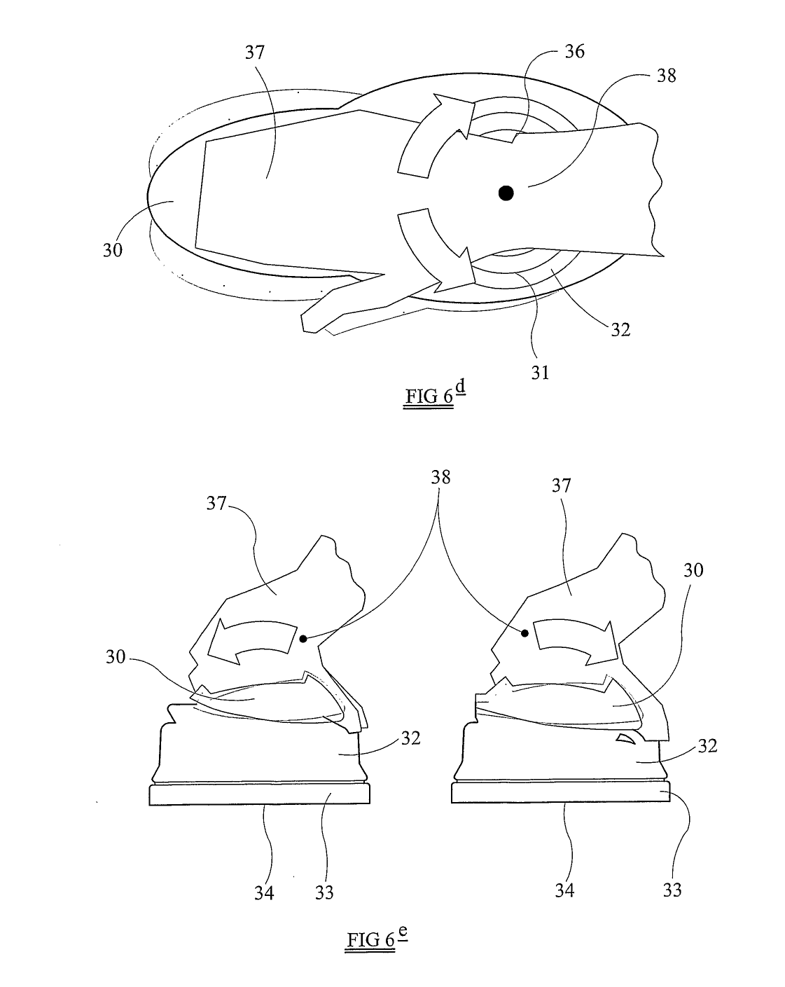

FIGS. 6a to 6e illustrate use of the computer input apparatus of FIGS. 5a to 5e;

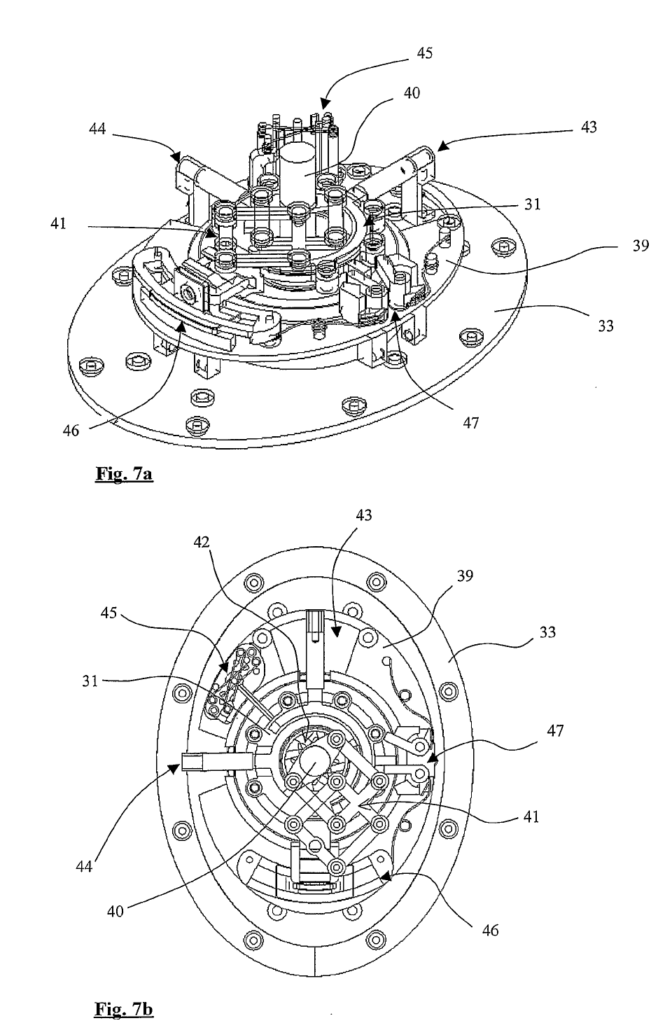

FIGS. 7a and 7b illustrate various mechanisms incorporated in the computer input apparatus of FIGS. 5a to 5e; and

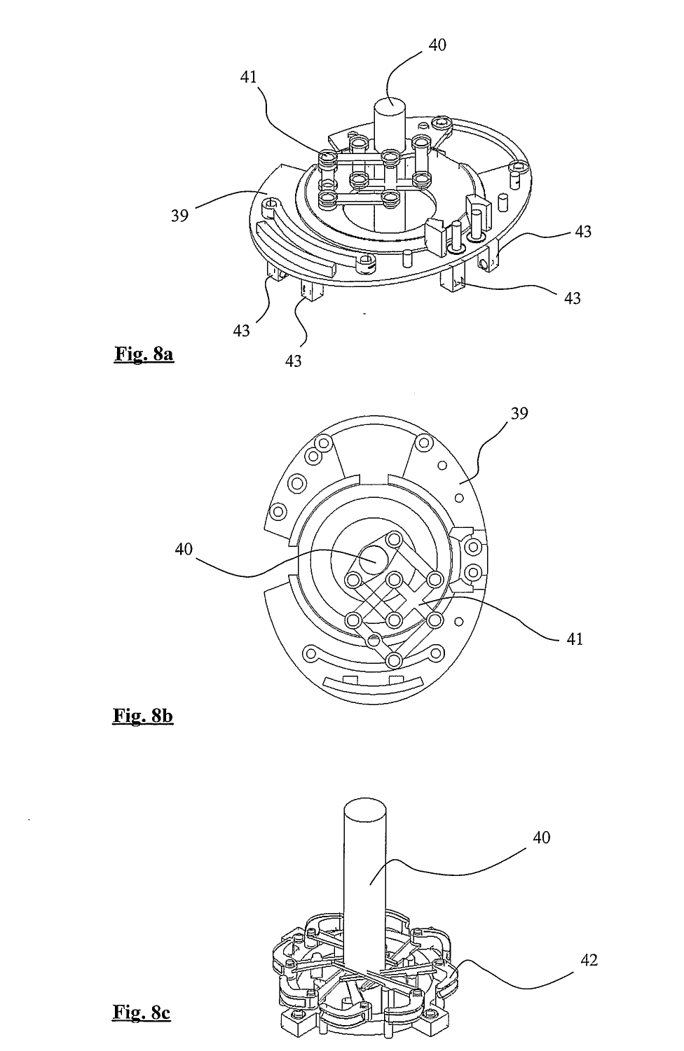

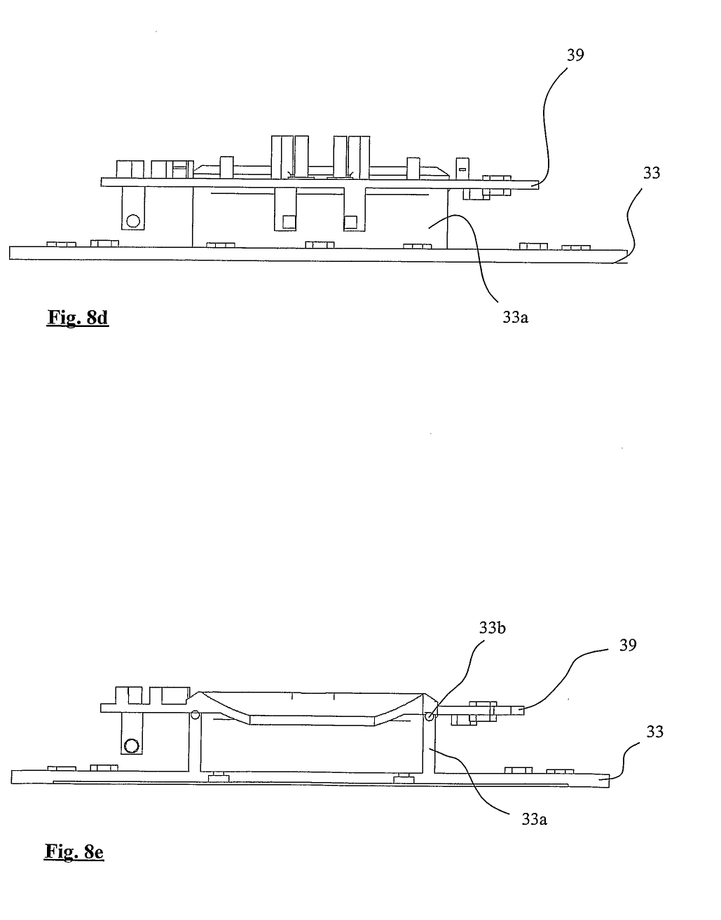

FIGS. 8 to 15 illustrate the mechanisms of FIGS. 7a and 7b in more detail.

It will be appreciated that the Figures that follow are schematic representations, and are not drawn to an accurate scale. Identical features are given identical reference numerals throughout the Figures.

FIG. 1 shows an external view of a computer input apparatus (hereinafter referred to as ‘the apparatus’) according to an embodiment of the present invention. The apparatus comprises a casing 1, which encases elements for controlling the operation and determining the functionality of the apparatus. The casing 1 is in connection with and moveable relative to a base plate 2. The casing 1 is provided with two input buttons 3a, 3b and an input scroll wheel 3c. The base plate 2 is provided with additional input buttons 3d. Attached to an underside of the base plate 2 is a non-slip surface 2a, provided to prevent movement of the base plate 2 relative to a surface on which it is placed. The apparatus further comprises an electrical cable 4 extending from the base plate 2. Elements encased by the casing 1, and the connection of the casing 1 to the base plate 2 are described in relation to FIG. 1b.

FIG. 1b is an exploded view of the apparatus of FIG. 1a, and illustrates elements encased within the casing, as well as elements attached to the base plate 2. Encased within the casing 1 is a post 5 that extends from an inner surface of the casing 1 and toward the base plate 2. The post 5 is arranged to control movement of the casing in a plane parallel to a surface on which the apparatus is placed, defined as an X-Y plane. The post 5 is hereinafter referred to as the ‘X-Y post 5’. The X-Y post 5 extends through a return to zero mechanism 6. The return to zero mechanism 6 is attached to a plate 10, and is arranged to bias the X-Y post 5 to a zero position. The return to zero mechanism 6 is described in more detail further below. The X-Y post 5 comprises a reflective surface 7 on its end, remote from the point of the casing to which the post 5 is attached. An optical sensor 7a is located on the base plate 2, in a position substantially beneath the X-Y post 5, and facing the reflective surface 7. The reflective surface 7 and optical sensor 7a are provided to detect movement of the X-Y post 5 in the X-Y plane, and are thus hereinafter referred to as ‘the X-Y reflective surface 7’ and ‘the X-Y optical sensor 7a’, respectively.

The casing further comprises two additional posts 8a, 8b, offset from the X-Y post 5, which extend from an inner surface of the casing 1 and toward the base plate 2. The additional posts 8a, 8b pass either side of, and not through the return to zero mechanism 6. The additional posts 8a, 8b extend toward and are connected to an anti-twist device 9, which is described in more detail further below. The anti-twist device 9 is in-turn connected to the plate 10 by way of connectors 10a. The plate 10 is provided to effect twist of the casing 1, and is hereinafter referred to as ‘the twist plate 10’. When appropriate, the connectors 10a serve in part to prevent twist of the casing 1, and thus hereinafter referred to as ‘anti-twist connectors 10a’. The twist plate 10 is connected to a further plate 11 by way of a plurality of clips 11a. The further plate 11 is provided to effect pivoting (or tilting) of the casing 1, and is thus hereinafter referred to as ‘the pivot plate 11’. The clips 11a allow the twist plate 10 to rotate relative to the pivot plate 11, and are thus hereinafter referred to as ‘the twist clips 11a’. The twist clips 11a protrude from an upper surface of the pivot plate 11, and snap into elongate recesses (not shown) on the underside of the twist plate 10. It will be appreciated that, alternatively, the twist clips 11a may protrude from the underside of the twist plate 10, and snap into elongate recesses on the upper surface of the pivot plate 11.

The twist plate 10 is shaped to form a mouth 10b, which receives a leaf spring 12. The leaf spring 12 is provided to bias the twist plate 10 to a zero or non-twisted position. Stops 13 are provided to limit the degree of twist of the twist plate 10, and are thus hereinafter referred to as ‘the twist stops 13’. A region of the underside of the mouth 10b of the twist plate 10 is provided with a reflective surface 14 (shown in dotted outline). An optical sensor 14a is located on the base plate 2, and faces the reflective surface 14. The reflective surface 14 and optical sensor 14a are provided to detect twist of the casing 1, and are thus hereinafter referred to as ‘the twist reflective surface 14’ and ‘the twist optical sensor 14a’, respectively.

An upper surface of the twist plate 10 is shaped to form an annular recess 15. Located within and extending around the annular recess 15 is a wavy washer 16. A wavy washer is a washer which is annular, and has a surface that undulates in a sinusoidal fashion such that it has spring like properties. When uncompressed, the wavy washer 16 is arranged to protrude from the annular recess 15, and bias an annular friction pad 17 from contacting the upper surface of the twist plate 10. The annular friction pad 17 is attached to an inner surface of the casing 1. The annular friction pad 17, wavy washer 16 and upper surface of the twist plate 10 together form a clutch mechanism, which is described in more detail further below.

The pivot plate 11 is provided with sprung shafts 11b which snap fit into pivot points 18 on the base plate 2, allowing the pivot plate 11 to pivot relative to the base plate 2. Coiled springs 19 are located between the pivot plate 11 and base plate 2, and are provided to bias the pivot plate 11 (and thus the casing 1) to a horizontal position. When the base plate is viewed from above (and using a clock face as an analogy), the pivot points are located at three o′clock and nine o′clock, and the coiled springs 19 are located at twelve o′clock and six o′clock. A reflective surface 20 (shown in dotted outline) is provided on a region of the underside of the pivot plate 11. An optical sensor 20a is located on the base plate 2, facing the reflective surface 20. The reflective surface 20 and optical sensor 20a are provided to detect pivoting of the casing 1, and are thus hereinafter referred to as ‘the pivot reflective surface 20’ and ‘the pivot optical sensor 20a’, respectively.

The return to zero mechanism 6, anti-twist device 9 and clutch mechanism are all particularly important parts of the apparatus, and are now described in more detail.

FIG. 2 shows a detailed view of the return to zero mechanism 6. The return to zero mechanism 6 comprises a support structure in the form of a ring 21. The ring 21 defines an aperture 22, through which the X-Y post 5 extends. Pivotably attached to the ring 21 are four diametrically opposed pairs of arms 23 (hereinafter referred to as ‘the return to zero mechanism arms 23’) arranged to surround the X-Y post 5. Adjacent return to zero mechanism arms 23 are pivotably attached to the ring at different heights, so that adjacent return to zero mechanism arms 23 may ride over one another. The return to zero mechanism arms 23 extend into the aperture 22, and are biased toward the centre of the aperture by a resilient O-ring O, which extends around the ring 21 and outermost parts of the return to zero mechanism arms 23. The biased return to zero mechanism arms 23 thereby resist movement of the X-Y post 5 and, when no pressure is applied to the casing and thus the X-Y post 5 (i.e. when a user removes his or her hand from the apparatus), serve to return the X-Y post 5 to a zero position. It will be appreciated that the biased return to zero mechanism arms 23 also serve to bias the X-Y post 5 toward the zero position even when pressure is applied by the user. Therefore, this gives the user a constant feeling of where the X-Y zero position of the apparatus is.

Each arm 23 comprises an inner stop 23a and an outer stop 23b. The inner stops 23a limit movement of the return to zero mechanism arms 23 away from the centre of the aperture 22, and thereby define a limit for the movement of the X-Y post 5. It will be appreciated that these inner stops 23a are not essential, and the ring 21 itself can act as the limit to X-Y movement of the X-Y post 5. The outer stops 23b limit movement of the return to zero mechanism arms 23 toward the centre of the aperture 22. Therefore, when a user does not apply a force to the casing 1 and X-Y post 5, the position and shape of the outer stops 23b determines the rest position of the return to zero mechanism arms 23, and thus the zero position of the X-Y post 5. The outer stops 23b are arranged such that the rest positions of the return to zero mechanism arms 23 in the centre of the aperture 22 together define a zero zone 24. The zero zone 24 has a diameter that slightly exceeds a diameter of the X-Y post 5, such that the post may be threaded through the zero zone 24 without a need to manipulate the positions of the return to zero mechanism arms 23. When the X-Y post 5 is returned to any position in the zero zone 24, no X-Y movement is input to the computer.

Although not essential, having a zero zone 24 with a diameter that slightly exceeds the diameter of the X-Y post 5 may be useful during the manufacture of the device, i.e. for threading the X-Y post 5 through the return to zero mechanism 6. Additionally, having a zero zone 24 with a diameter that slightly exceeds the diameter of the X-Y post 5 ensures that individual return to zero mechanism arms 23 are not pushing the X-Y post 5 against other return to zero mechanism arms 23. This may be useful when individual springs are used to bias each return to zero mechanism arm 23, and when these individual springs are of unequal strengths, because this would otherwise cause the more strongly sprung return to zero mechanism arms 23 to push the X-Y post 5 in the direction of the more weakly sprung return to zero mechanism arms 23, and possibly out of the zero zone 24. Preferably, a resilient O-ring is used to bias the return to zero mechanism arms 23, as this avoids the abovementioned problem where individual return to zero mechanism arms 23 are unevenly biased (i.e. an O-ring ensures that the return to zero mechanism arms 23 are equally biased). Notwithstanding this, springs may be used to bias the return to zero mechanism arms 23.

In having individually mounted return to zero mechanism arms 23, with appropriately placed stops 23a, 23b, the return to zero mechanism of the present invention can accurately and consistently return the position of the X-Y post 5 to zero. The inner and outer stops 23a, 23b serve to define accurate limitations for the movement of the return to zero mechanism arms 23 and/or the X-Y post 5. The biased and pivotably mounted return to zero mechanism anus 23 allow a smooth and repeatable return to zero. By using an O-ring O to bias the return to zero mechanism arms 23, the return to zero mechanism 6 does not require springs, which are known to generate noise when made to expand or contract. Therefore the return to zero mechanism 6 operates extremely quietly. In surrounding the X-Y post 5 with overlapping return to zero mechanism arms 23, the return to zero mechanism 6 of this embodiment of the invention is uniform—i.e. the return to zero is consistent wherever the X-Y post 5 is located in the aperture 22. Furthermore, the tension of the O-ring O biasing the return to zero mechanism arms 23 can be altered (or the O-ring O replaced) in order to customise the biasing of the X-Y post 5 toward the zero position. For example, this maybe desirable for increasing comfort of the user or sensitivity of the apparatus. The return to zero mechanism of this embodiment of the present invention does not suffer the wear and stress fractures of some prior art return to zero mechanisms, which use other means, such as bent pieces of plastic (which act as springs), to return the (X-Y) post to zero.

It will be appreciated that the O-ring O may be made of any suitable material. Most preferably, the material is resilient, such that it returns to its initial shaped after being stretched. The O-ring O may be located at any suitable location, so long as it acts to bias the return to zero mechanism arms 23. The O-ring O may be located in indentations or other retaining means, provided in the return to zero mechanism arms 23 to prevent the O-ring from becoming displaced.

It will be appreciated that it is not essential that the return to zero mechanism 6 has four pairs of arms 23 attached to it. For example, the return to zero mechanism 6 may have two pairs of arms attached to the support structure 21, or even a single pair. Furthermore, the use of an odd number of arms 23 may be advantageous. For example, three, five, seven or nine arms 23 may be attached to the support structure 21. It will be appreciated that the more arms 23 that are attached to the support structure 21, and extend therefrom into the aperture 22, the more circular the zero zone 24 will be. A more circular zero zone may be preferable, as this would ensure a more uniform return to zero. Preferably, the arms 23 are opposable, such that movement of the X-Y post 5 in a first direction pushes at least one arm 23 away from the centre of the aperture 22, whereas movement of the X-Y post 5 in a second direction pushes at least one different arm 23 away from the centre of the aperture 22. The arms may be straight or curved.

FIG. 3a shows the anti-twist device 9. The anti-twist device is sometimes referred to as a pantograph. An example of an anti-twist device is shown in, for example, U.S. Pat. No. 5,491,477. The anti-twist device 9 is provided with a plate 25 (hereinafter referred to as ‘the anti-twist plate 25’) that is square in shape, and has four corners. The anti-twist device 9 is also provided with four arms 26, 27, 28, 29 (hereinafter referred to as ‘the anti-twist arms 26, 27, 28, 29’) that are pivotably connected to each corner of the anti-twist plate 25 by a first end 26a, 27a, 28a, 29a of a respective arm. The arms 26, 27, 28, 29 are split into pairs, each pair comprising arms that are attached to the anti-twist plate 25 at opposite corners (i.e. so that a line drawn between a first pair of arms would bisect a line drawn between a second pair of arms, the point of bisection being located in the centre of the anti-twist plate 25). A first pair of anti-twist arms 26, 27 have their second ends 26b, 27b pivotably connected to the twist plate 10 of the computer input apparatus, via the anti-twist connectors 10a shown in FIG. 1b. A second pair of anti-twist arms 28, 29 have their second ends 28b, 29b pivotably connected to the casing of the computer input apparatus, via the additional posts 8a, 8b shown in FIG. 1b. The pivotable connections are snap fits, but maybe any other form of pivotable connection such as pins or screws.

FIG. 3a shows the situation where the casing has not been moved in the X-Y plane. It can be seen that the first pair of anti-twist arms 26, 27 are perpendicular to the second pair of anti-twist arms 28, 29.

FIG. 3b shows the anti-twist device 9 when the casing has been moved in an X-direction, and also, in dotted outline, the initial, unmoved position. The first pair of anti-twist arms 26, 27 are connected by their second ends 26b, 27b to the twist plate 10, which is unable to move in an X-Y direction, and these points of connection are therefore fixed in position. In order to accommodate for the movement of the casing, and therefore the movement of the second pair of anti-twist arms 28, 29 to which the casing is attached, the anti-twist plate 25 moves and all of the anti-twist arms 26, 27, 28, 29 pivot about their connection points as a result.

Referring to FIGS. 1 and 3, if a user of the apparatus attempts to twist the casing 1, whilst applying little or no downward pressure (the significance of which will be described further below), the casing 1 will not twist. Twisting of the casing 1 will cause one of the additional post 8a, 8b as seen in FIG. 1a to attempt to move in the positive X direction, and the other in negative X direction. As the second ends 28b, 29b of the second pair of anti-twist arms 28, 29 are connected to the additional posts 8a, 8b, one of the anti-twist arms of the second pair 28, 29 will attempt to move in the positive X direction, and the other in negative X direction. In short, the anti-twist plate 25 itself will attempt to twist. However, any force attempting to twist the anti-twist plate 25 will be counteracted by the rigidity of the first pair of anti-twist arms 26, 27, which are attached to the twist plate 10. Any twisting force attempting to twist the anti-twist plate 25 will attempt to cause twist of the anti-twist plate 25 in a direction substantially parallel to the direction in which the first pair of anti-twist arms 26, 27 extend to the twist plate 10. As the anti-twist connectors 10a on the twist plate 10 cannot twist relative to each other, twist of the anti-twist plate 25, and therefore the casing 1, without applying a downward force is not possible without damage or destruction to the anti-twist device 9.

In summary, the additional posts 8a, 8b can twist relative to each other, which in turn would cause the anti-twist plate 25 to attempt to twist. However, as the anti-twist connectors 10a to which the anti-twist plate 25 is also connected cannot twist relative to one another, twist of the anti-twist plate 25 is prevented, as is that of the additional posts 8a, 8b and casing 1.

Twist of the casing relative to the base plate is, however, possible if sufficient downward pressure is applied to the casing 1. This is described in relation to FIGS. 4a and 4b, which illustrate a clutch mechanism in accordance with an embodiment of the present invention. FIG. 4a shows the casing 1, which has attached to it the annular friction pad 17. The annular friction pad 17 is biased away from contact with the upper surface of the twist plate 10 by the wavy washer 16, which is located in and protrudes from the annular recess 15. The anti-twist device 9 is shown for reference.

A clutch mechanism is formed by the annular friction pad 17, the wavy washer 16 and the upper surface of the twist plate 10. When no downward pressure is applied to the casing 1, and therefore the annular friction pad 17, the anti-twist device 9 operates as described above; no twist of the casing 1 is possible. However, twist of the casing 1 is possible when sufficient downward pressure is applied to the casing 1 to overcome the bias of the wavy washer 16, and to make the annular friction pad 17 come into substantial contact with the upper surface of the twist plate 10, as shown in FIG. 4b. The wavy washer 16 recedes into the annular recess 15 to allow the annular friction pad 17 to make substantial, even a flush contact with the upper surface of the twist plate 10. When such contact is made, the clutch is engaged.

When the clutch is engaged (i.e. when the annular friction pad 17 is brought into substantial contact with the upper surface of the twist plate 10), any twist of the casing 1 is directly transferred to the twist plate 10, which twists to the same extent as the casing 1. The anti-twist device 9 does not prevent twist when the clutch is engaged. This is because the anti-twist device 9 is connected to both the casing 1 and the twist plate 10. Since these all twist to the same extent, the anti-twist device 9 is effectively disengaged, since it does not and cannot (attempt to) twist relative to the casing 1 or twist plate 10. The anti-twist device 9 can be engaged (i.e. made to prevent twist) by disengaging the clutch mechanism, so that the annular friction pad 17 is no longer in contact with upper surface of the twist plate 10.

Preferably, the annular friction pad 17 and/or the upper surface of the twist plate 10 have high coefficients of friction. It will be appreciated that the upper surface of the twist plate 10 can be treated, or have a high-friction surface attached to it in order to maximise the transfer of twist from the casing 1 and the annular friction pad 17 to the twist plate 10.

It will be appreciated that the wavy washer 16 could be replaced with a coil spring or a disc spring, or any other suitable biasing member. For example, the wavy washer 16 could be replaced with an annular ring of a sponge like material. A biasing member having a structure that can accommodate shear forces is a particularly preferable choice. This may reduce wear on the biasing member thereby increasing the lifetime of the device. A biasing member having such a structure is a coil spring, the top of which can move laterally relative to the base.

Preferably, the biasing member is shaped so as to have a minimal area in contact with the annular friction pad 17 when the biasing member is uncompressed, such that X-Y movement of the casing 1 and annular friction pad 17 does not cause a large amount of wear on the biasing member. For example, the wavy washer 16 may have a circular (as opposed to rectangular) cross section, such that contact with the annular friction pad 17 is minimised when the wavy washer is uncompressed. An annular recess 15 is not essential, and the wavy washer 16 itself may, when compressed between the annular friction pad 17 and upper surface of the twist plate 10, have a large enough coefficient of friction to engage the clutch mechanism.

All of the components of the computer input apparatus are formed in a conventional manner. The majority of the components are made from plastic mouldings, as is known in the art (e.g. injection moulding techniques). The wavy washer 16 is made from a metal such as steel, and the annular friction pad from a high friction rubber. It will be appreciated, however, that the computer input apparatus can be made from any suitable material.

Use of the above-mentioned apparatus will now be described with reference to FIGS. 1 to 4. In use, the computer input apparatus is connected to a computer by the electrical cable 4. Movement of the casing 1 relative to the base plate 2 causes an input signal to be sent to the computer via the electrical cable 4.

The casing 1 is moveable relative to the base plate 2 in all directions in a plane parallel to the base plate 2 i.e. in the X-Y plane. The casing 1 is also able to twist and pivot relative to the base plate 2.

Moving the casing in the X-direction for example, the X-Y post 5 which passes through the return to zero mechanism 6 pushes against the biased arms 23 thereof. At the same time, the X-Y reflective surface 7 at the end of the X-Y post 5 interacts with the X-Y optical sensor 7a such that movement of the X-Y post 5, and thus the casing 1, can be detected and input into the computer. When the user releases the casing 1, it is returned to a zero position by the return to zero mechanism 6. No X-Y movement signal is sent to the computer when the casing 1 has been returned to zero and the X-Y post 5 is in the zero zone 24.

Twist of the casing 1 relative to the base plate 2 is not possible without applying any downward pressure to the casing 1, thereby engaging the clutch mechanism. This ensures that movement in the X and/or Y directions is not subject to twist. This can be extremely beneficial when, for example, controlling the position and orientation of a character in a computer game, where simultaneous X-Y movement with twist is not desirable. Such anti-twist functionality is useful in any situation where twist is undesirable.

By applying downward pressure to the casing 1, the clutch mechanism is engaged, and permits twist of the casing 1. As described above, when downward pressure is applied, the annular friction pad 17 contacts the upper surface of the twist plate 10, such that twist of the casing 1 and the annular friction pad 17 that is attached to it causes twist of the twist plate 10. When the twist plate 10 is twisted, the mouth 10b of the twist plate biases the leaf spring 12 in the direction of twist. At the same time, the twist reflective surface 14 located on the underside of the mouth 10b of the twist plate 10 interacts with the twist optical sensor 14a such that twist of the twist plate 10, and thus the casing 1, can be detected and input into to the computer. The twist stops 13 limit the degree of twist of the twist plate 10 and thus casing 1. When the user releases the casing 1, it is twisted back to a zero position by the leaf spring 13. No twist signal is sent to the computer when the casing 1 has been returned to zero.

When sufficient downward pressure is applied to the casing 1 to twist it, the friction between the annular friction pad 17 and upper surface of the twist plate 10 may be such that X-Y movement of the casing 1 is not possible when the clutch is engaged. However, it will be appreciated that it is possible for the casing to be twisted and moved in the X-Y direction simultaneously. The user needs to apply sufficient downward pressure on the casing 1 to engage the clutch mechanism, but not so much pressure that X-Y movement is prevented. It will be appreciated that such simultaneous movement will require some skill to achieve (but will in practice be largely intuitive), but that this adds additional functionality to the computer input apparatus. Such simultaneous twist and X-Y movement functionality may be desirable for experienced players of computer games, who may wish to rotate an onscreen character at the same time as looking around the gaming environment, which corresponds to simultaneous twist and X-Y movement of the casing 1 respectively.

The casing 1 may be pivoted about pivot points 18 by applying downward pressure to the front or back of the casing 1. This causes the pivot plate 11 to pivot about pivot points 18. At the same time, the pivot reflective surface 20 located on the underside of the pivot plate 11 interacts with the pivot optical sensor 20a such that pivoting of the pivot plate 11, and thus the casing 1, can be detected and input into the computer. When the user releases the casing 1, it is returned to a zero position by the coiled springs 19. No pivot signal is sent to the computer when the casing 1 has been returned to zero.

The embodiment described above shows the casing 1 pivotably connected to the anti-twist mechanism 9 via the additional posts 8a, 8b (which are attached to the casing 1) and the second ends of the second pair of anti-twist arms 28, 29 (which are attached to the anti-twist plate 25). There are no other connections between the casing 1 and other constituent parts of the computer input apparatus. In some circumstances, it may be desirable to increase the number of connections between the casing 1 and other constituent parts of the computer input apparatus, specifically to increase the rigidity and maintain the structural integrity of the input apparatus. Such further connections must allow rotation, pivoting and X-Y movement of the casing 1 relative to the base plate 2. For example, further posts may depend from the casing 1, and be connected to the twist plate 10. The posts may pass through apertures in the twist plate that are sufficient in size to allow sufficient rotation, pivoting and X-Y movement of the casing 1 relative to the base plate 2. The posts may extend through and beneath the twist plate 10, where the posts are shaped to have an expanded section that prevents the posts from being removed from the twist plate 10 (i.e. the expanded section is larger than the twist plate apertures in at least one dimension). In incorporating such further connections, the casing 1 has more support, and the input apparatus as whole has a more rigid structure without suffering a loss in functionality.

Activation of the input buttons and scroll wheel 3a, 3b, 3c, 3d may be undertaken in a manner well known in the art, and will therefore not be described in detail here. It will be appreciated that, as is known in the art, activators for the input buttons and scroll wheel 3a, 3b, 3c, 3d, as well as any required control circuitry, may be sandwiched between two casings of the input apparatus, negating the need to have wires and cables housed within the casing 1. A first casing may be an aesthetic casing, whereas a second casing, sandwiching the activators for the input buttons and scroll wheel 3a, 3b, 3c, 3d as well as any required control circuitry, will house the mechanisms for controlling the movement of the input apparatus (as described above). It will be appreciated that the first and second casing will be attached to one another, such that movement of the first aesthetic casing will effect direct movement of the second casing housing the mechanisms for controlling the movement of the input apparatus.

It will be appreciated that, with sufficient skill, the casing 1 may be moved in the X-Y plane, twisted and pivoted simultaneously by applying appropriate downward pressure to the casing 1.

The anti-twist device 9 may be different in form from that described above. For example, the anti-twist plate 25 of the anti-twist device may be circular in shape. More generally, the anti-twist device 9 may be any suitable anti-twist device that can be disengaged (i.e. such that the casing 1 is allowed to twist) by engagement of the clutch mechanism, as described above.

It will be apparent to one of ordinary skill in the art that the coil springs 19 (shown in FIG. 1b) may be replaced with any suitable biasing member, such as a leaf spring. It will also be apparent that the leaf spring 12 (shown in FIG. 1b) may be replaced with any suitable biasing member, such as a coil spring.

The optical sensors and reflective surfaces mentioned above are standard movement detection elements employed in the art. The skilled person will appreciate that the form and position of the optical sensors and reflective surfaces may vary, so long as X-Y movement, twist and pivot of the casing can be detected and converted to an input signal. For example, a twist reflective surface may be made to extend from the twist plate 10, such that it may interact with a twist sensor which extends from the pivot plate 11. In this way, pivoting of the casing 1 (and thus the twist plate 10) will not effect measurement of the degree of twist of the casing 1. Hall Effect sensors, or other suitable sensors may be used in place of the optical sensors mentioned above. For example, capacitive, pressure, electromagnetic, gyroscopic or galvanomagnetic sensors may be used. It will be appreciated that a single sensor may be used to detect movement in more than one direction. For example, a single sensor may be used to detect movement of twist and tilt of the casing, thus reducing the number of sensors required.

It will be appreciated that movement of the casing, be it twist, pivot or X-Y movement can be detected and/or processed as an analogue or digital signal. For example, the computer input apparatus can be configured to input a discrete (digital) twist clockwise or twist anticlockwise signal. Alternatively, the computer input apparatus can be configured to input a continuous signal (analogue) comprising the degree to which the apparatus has been twisted in a clockwise or anticlockwise direction.

It will be appreciated that the above-mentioned embodiment can be used as a computer mouse, a joystick or a combination of the two.

Preferably, movement of the casing in any one direction is limited to +/−5 mm. This limitation allows the device to remain small, while still allowing the degree of movement to be accurately resolved.

It will be appreciated that control electronics will be required to detect movement of the casing 1, and to process and send movement signals to a computer or the like. Such control electronics are well known in the art, and will not be described in more detail here.

It will be further appreciated that appropriate software may need to be installed on a computer in order for the computer input apparatus to be recognised and function fully. This software may present to the user customisable control options, such as, for example, deactivation of the twist or pivot functions, or the assignment of functions to the input buttons and scroll wheel. The software may also be used to set some or all of the movement signals of the apparatus to be processed in digital or analogue mode, and also the sensitivity of these modes. Alternatively, the switching between digital and analogue modes may be achieved by the changing of a position of a mechanical switch on the apparatus.

The embodiment described above allows a user to effect movement in four axes (X, Y, twist and pivot) using only a single hand, leaving another hand free to effect activation of (other) control buttons. This allows the user to accurately control movement of the input apparatus while simultaneously giving the user an entire hand to control a further device (e.g. a keyboard). Additionally, the buttons and control wheel on the input apparatus may be deactivated to allow the user to move the input apparatus without risk of activation of the buttons and/or control wheel. Such functionality allows the user to more accurately control movement of the input apparatus. Additionally, the computer input apparatus of the present invention does not favour left or right-handed users—it is an ambidextrous device. Any cabling connecting the computer input apparatus to a computer or console may be appropriately placed such that it does not hinder use thereof by either left or right-handed people.

FIG. 5a is a perspective view of a computer input apparatus according to another embodiment of the present invention. The computer input apparatus comprises a handle 30 which is attached to a ball segment 31. The ball segment (herein after referred to as “the ball 31”) is substantially hemispherical in shape, and is formed with a slightly concave upper surface for receiving the wrist of a user. The ball segment 31 is received by a socket 32, thus forming a ball 31 and socket 32 arrangement. FIGS. 5d and 5e illustrate the computer input apparatus in cross section, so that the ball 31 and socket 32 arrangement may be more easily visualised and understood. Referring back to FIG. 5a, the socket section 32 (herein after referred to as “the socket 32”) is connected, and moveable relative to, a base plate 33. The base plate is provided with a non-slip pad 34 to prevent movement of the base plate 33 relative to a surface on which the computer input apparatus is placed.

The handle 30 is provided with two buttons 35 in much the same way as a mouse for a computer (it will be appreciated that any desirable number of buttons may be provided). The handle 30 is shaped to fit comfortably in the palm of a user's hand, and is shaped like the casing of a conventional mouse. The handle 30 is positioned such that when a user uses the computer input apparatus, the user's wrist is located on top of the ball 31, which supports the user's wrist. A gel pad 36 is provided on top of the ball 31 to provide support for the wrist of the user and to ensure that the computer input apparatus is comfortable to use.

As with any conventional ball and socket arrangement, the ball 31 of the computer input apparatus may move in a number of directions. These directions may be visualised with the aid of FIGS. 5b and 5c which show the computer input apparatus in side and plan views respectfully. By holding the handle 30, and placing their wrist on the gel pad 36 of the ball 31, the handle may be pivoted (i.e. rotated about a first axis) which, since the handle 30 is attached to the ball 31, will also cause the ball 31 to pivot in the socket 32. If the handle 30 is gripped and is banked (i.e. rotated about a second axis, orthogonal to the first axis) the ball 31 to which the handle 30 is attached will also roll. If the handle is twisted (i.e. rotated about a third imaginary axis, orthogonal to the first and second axes) the ball 31 to which the handle 30 is attached will also twist.

If the handle 30 is gripped and moved in an x-y direction (i.e. in a plane parallel to a surface on which the computer input apparatus is placed) the ball 31 does not pivot, twist or bank. Instead, the socket 32 in which the ball is located is moved in the same direction in the x-y plane as the handle 30, because the socket 32 is moveable relative to the base plate 33.

In summary, by appropriate control of the handle 30, parts of the computer input apparatus can be made to move in an x-y plane, pivot, twist and/or bank without the base plate 33 moving relative to the surface on which the computer input apparatus is placed. The mechanisms which allow the computer input apparatus to allow and detect movements, are described in more detail below.

As mentioned above, a user of the computer input apparatus will grip the handle 30 in such a way that the wrist of the user is placed on and supported by the gel pad 36, which is attached to the ball 31 (i.e. the ball 31 supports the wrist, and the gel pad 36 provides a cushioning surface). The significance of this configuration will now be described in relation to FIGS. 6a to 6e.

FIGS. 6a to 6e illustrate how a user 37 interacts with and uses the computer input apparatus of FIGS. 5a to 5e. FIGS. 6a and 6b show how the user 37 moves the handle 30 and also the socket 32 in the x-y plane. FIG. 6c shows how the handle 30 and ball 31 are pivoted by the user 37. FIG. 6d shows how the user 37 twists the handle 30 and the ball 31. FIG. 6e shows how the user would bank the handle 30 and ball 31.

It can be seen that in all movement regimes, the wrist 38 is positioned directly above the centre of the ball 31 and in contact with the gel pad 36 (or, more generally, indirect contact with the ball 31). Since the wrist 38 of the user 37 is supported in all movement regimes, the computer input apparatus is comfortable to use. The chances of incurring RSI (repetitive strain injuries) are reduced or avoided since the wrist is not under strain. Since the wrist 38 of the user 37 is positioned directly above the centre of the ball 31, minimal movement of the wrist 38 is required to effect the required movements of the handle 30 and ball 31.

The mechanisms which allow the particularly advantageous ball 31 and socket 32 arrangement to be used in the computer input apparatus of the present invention are described below in relation to FIGS. 7 to 15.

FIGS. 7a and 7b show the mechanisms which allow the ball 31 to be twisted, pivoted and banked, as well as allowing a part of the computer input apparatus to be moved in the x-y plane, as well as detecting these movements. FIG. 7a shows the mechanisms in perspective, whereas FIG. 7b shows the mechanisms in plan view. The computer input apparatus is provided with a plate 39 which is connected to and moveable relative to the base plate 33. Plate 39 is moveable in the x-y plane (i.e. in a plane parallel to the base plate 33), and is herein after referred to as the “x-y plate 39”). The x-y plate 39 receives the ball 31. Extending through the ball 31 and the x-y plate 39 in a direction perpendicular to the base plate 33 is a shaft 40. The shaft 40 interacts with an anti-twist mechanism 41 to ensure accurate x-y movement of the x-y plate 39. A first return to zero mechanism 42 is provided to ensure that the shaft 40 and x-y plate 39 are returned to a zero (i.e. equilibrium position).

The computer input apparatus is also provided with a pivot mechanism 43, which allows the ball 31 to pivot, and also detects pivoting of the ball 31. The computer input apparatus is further provided with a bank mechanism 44, which allows the ball 31 to be banked, and also detects banking of the ball 31. The ball 31 is attached to a second return to zero mechanism 45, which moves the ball 31, pivot mechanism 43 and bank mechanism 44 to a zero (i.e. equilibrium) position when no banking or pivoting force is applied to the ball 31.

The computer input apparatus is further provided with a twist mechanism 46, which allows the ball 31 to be twisted, and also detects twisting of the ball 31. The twist mechanism 46 is provided with a third return to zero mechanism 47, which returns the ball 31 and twist mechanism 46 to a zero (i.e. equilibrium) position where no twisting force is applied to the ball 31.

Each of the above mentioned mechanisms are described in more detail below.

FIG. 8a shows the x-y plate 39 in perspective, and FIG. 8b shows the x-y plate 39 in plan view. The shaft 40 extends through the x-y plate 39. The anti-twist mechanism 41 is attached to the shaft 40. As described in relation to FIGS. 3a and 3b, the anti-twist mechanism 41 is a pantograph, and prevents relative rotation between structures to which it is connected. For example, if the anti-twist mechanism 41 is connected between the x-y plate 39 and the base plate 33 of FIG. 7a, the x-y plate 39 can only move in the x and y directions and cannot twist. Such a connection is not shown in the FIG. 7a or 7b for reasons of clarity, and because it has already been described in detail in FIGS. 3a and 3b.

The ball 31 and handle 30 shown in FIG. 5a are not shown in FIG. 8a. However, movement of the ball 31 in the x-y plane moves the x-y plate 39 in the x-y plane. Movement of the x-y plate 39 in the x-y plane is detected by Hall Effect sensors (not shown) which are fixed in position relative to the base plate 33. The x-y plate 39 is provided with magnets 43 which are located about the Hall Effect sensors on the base plate. Movement of the x-y plate 39 causes movement of the magnets 43 about the Hall Effect sensors, which allows the movement of the x-y plate 39 to be detected by the Hall Effect sensors (detecting movement of a magnet using a Hall Effect sensor is well known, and is therefore not described in more detail here).

FIG. 8c shows how the shaft 40 extends through the first return to zero mechanism 42. The first return to zero mechanism 42 is identical to that shown in and described with reference to FIG. 2, and will therefore not be described in detail here. However, in summary, the first return to zero mechanism comprises a plurality of biased arms, which when moved by movement of the shaft 40, tend to push the shaft 40 back to the centre of the return to zero mechanism 42. Thus, the first return to zero mechanism 42 tends to push the shaft 40 to a zero (or equilibrium) position. The first return to zero mechanism 42 is fixed to the base plate 34 (shown in FIG. 5a), and restricts x-y movement of the shaft 40. The shaft 40 is attached to the ball 31, and so the first return to zero mechanism 42 restricts x-y movement of the ball 31 and also the handle 30.

FIG. 8d illustrates the relationship between the x-y plate 39 and the base plate 33. The x-y plate 39 sits on top of a seat 33a provided on the base plate 33. FIG. 8e shows FIG. 8d in cross section. It can be seen that the seat 33a is provided with a PTFE ring 33b, which provides a low friction surface over which the x-y plate 39 can move.

FIG. 9a is a simplified perspective view of the mechanisms illustrated in FIG. 7a. FIG. 9b in a simplified plan view. Only the pivot mechanism 43, bank mechanism 44, second return to zero mechanism 45, twist mechanism 46 and third return to zero mechanism 47 are shown in FIGS. 9a and 9b so that the reader may more easily see these mechanisms (i.e. the first return to zero mechanism 42, anti-twist mechanism 41 and a base plate 43 have been removed for clarity). The pivot mechanism 43, bank mechanism 44, second return to zero mechanism 45, twist mechanism 46 and third return to zero mechanism 47 are described in more detail below.

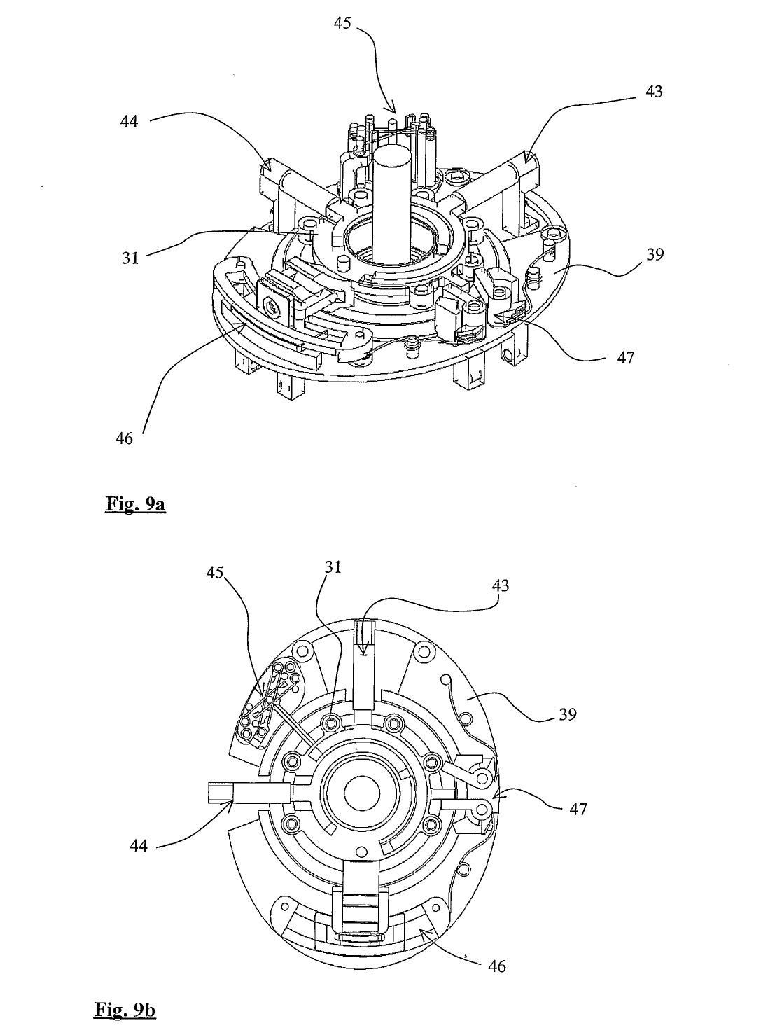

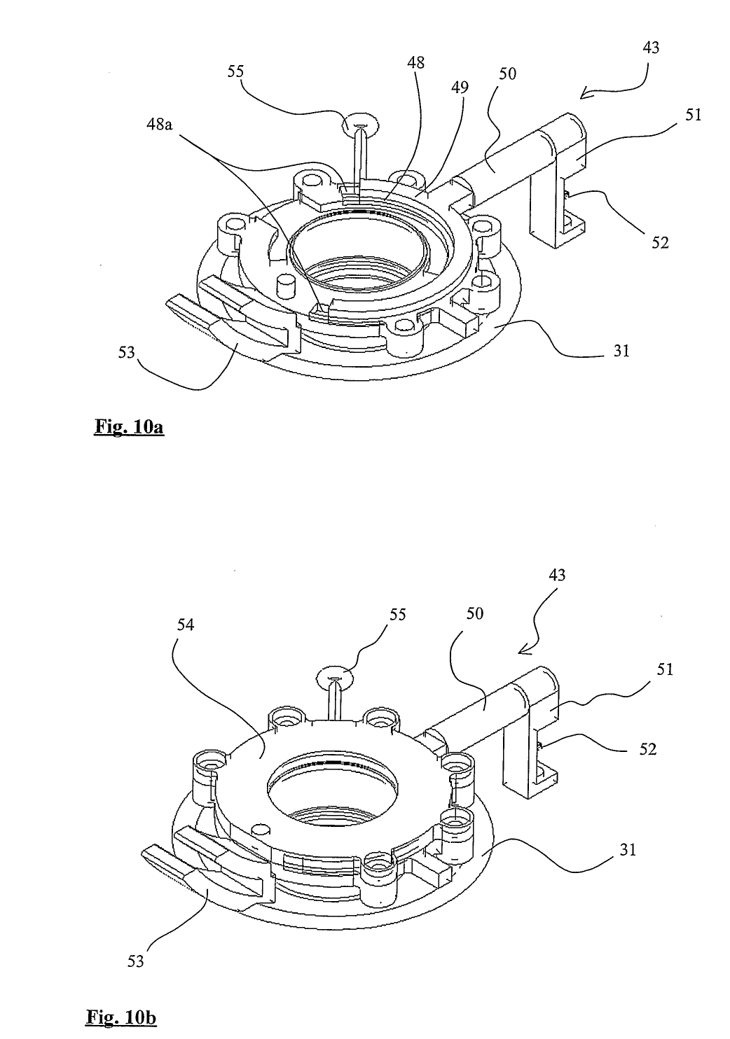

FIGS. 10a and 10b illustrate the pivot mechanism 43, and how the pivot mechanism detects pivoting of the ball 31. The ball 31 is provided with a C-shaped recess 48. In this recess sits a C-shaped member 49. The C-shaped member 49 is attached, by way of an arm 50, to a magnet 51. The magnet partially surrounds a Hall Effect sensor 52 which is able to detect movement of the magnet 51.

The arm 50 extends directly away from the ball 31 and is positioned opposite the handle 30 (shown in FIG. 5a). The Hall Effect sensor 52 is fixed in position relative to the x-y plate 39 (shown in FIG. 7a), so that movement of the x-y plate 39 in the x-y plane is not detected by the Hall Effect sensor 52. The positioning of the min 50 and Hall Effect sensor 52 are configured such that only pivoting of the ball 31 may be detected by the Hall Effect sensor 52. It can be seen from FIG. 10a that the C-shaped recess 48 is slightly longer than the C-shaped member 49. Thus, two spaces 48a are formed in the C-shaped recess 48, one at either end of the C-shaped member 49. The spaces 48a allow the ball 31 to be twisted without moving the C-shaped member 49, and also the arm 50 and magnet 51 to which the ball 31 is attached. This is because when the ball 31 is twisted, the C-shaped member 49 slides into the spaces 48a. Thus, twisting of the ball 31 does not affect the measurement of the degree of pivoting of the ball 31.

The ball 31 is provided with a fork 53 which interacts with the twist mechanism 46 (not shown in FIG. 10a or 10b) so that pivoting of the ball 31 does not affect the measurement of twist of the ball 31. This feature is described in more detail below.

FIG. 10b shows the features of FIG. 10a, but with a cap 54 mounted on the ball 31, which keeps the C-shaped member 49 in the C-shaped recess 48 when the ball 31 is pivoted.

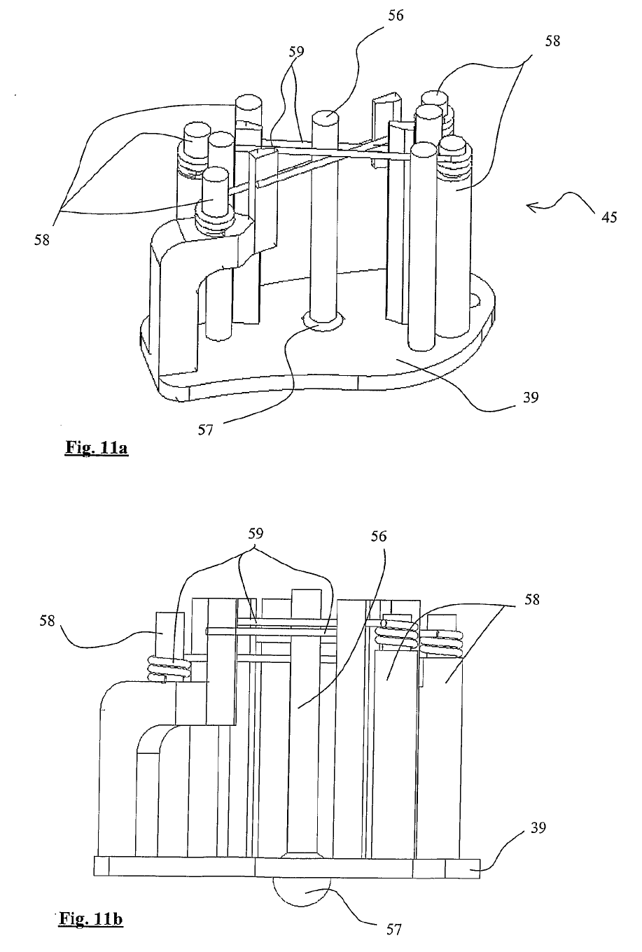

It can be seen from FIGS. 10a and 10b that the ball 31 is provided with an arm 55 which extends away from the ball 31. The arm 55 is attached to the second return to zero mechanism, shown in FIGS. 11a and 11b. The second return to zero mechanism 45 is arranged to return the ball 31, once pivoted, to a zero (i.e. equilibrium) position when a force causing the ball 31 to be pivoted is no longer applied. The second return to zero mechanism 45 is fixed in position on the x-y plate 39 (shown in FIG. 7a). The second return to zero mechanism 45 is provided with a shaft 56. The shaft 56 is fixed to the x-y plate 39 by way of a ball and socket arrangement 57. The shaft 56 is connected to the ball 31 (shown in FIG. 10a) by the arm 55. Due to the fact that the shaft 56 is attached to the x-y plate 39 by way of a ball and socket arrangement 57, the shaft 56 can tilt and bank in response to tilting and banking of the ball 31.

Surrounding the shaft 56 of the second return to zero mechanism 45 are a plurality of pillars 58. Attached to some of the pillars 58 are biased arms 59 which extend around the shaft 56. If the shaft 56 is titled or bent, it pushes against the arms 59. In response, since the arms 59 are biased, the arms push the tilted or bent shaft 56 back to its zero (i.e. equilibrium) position. Some of the pillars 58 are not provided with biased arms 59, but act as stops to prevent excessive banking or tilting of the shaft 56 and thus the ball 31.

It will be appreciated that the second return to zero mechanism 45 could be formed directly on the x-y plate 39, or formed on a secondary plate, which is attached to the x-y plate 39.

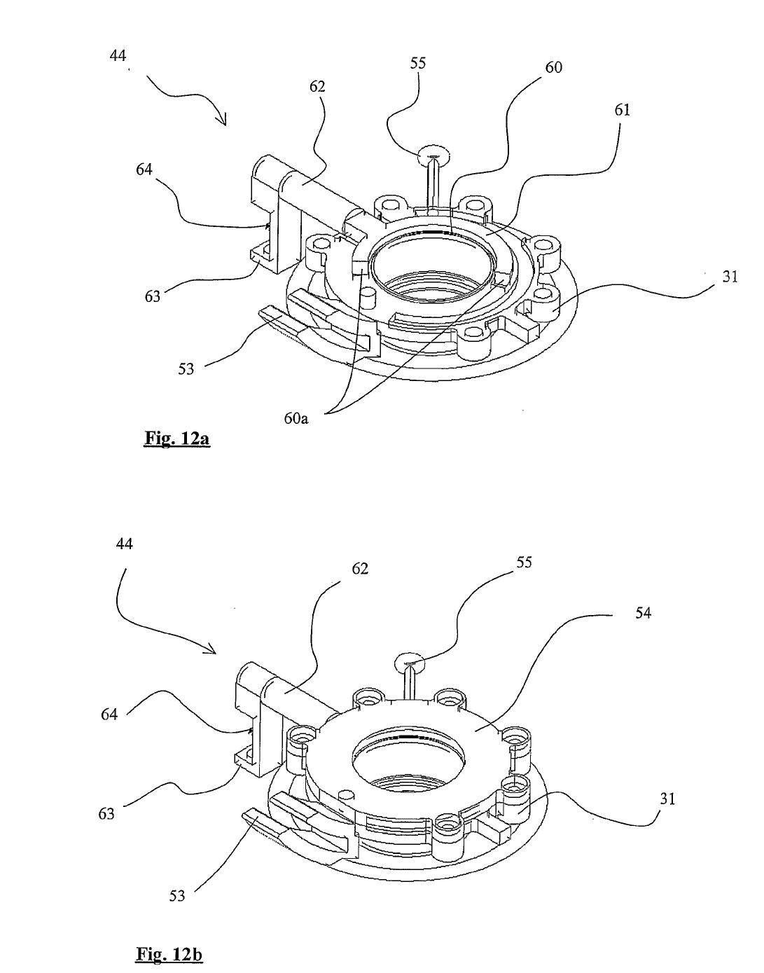

FIGS. 12a and 12b illustrate the operation of the bank mechanism 44. The ball 31 is provided with an additional C-shaped recess 60 an additional C-shaped member 61 sits in the additional C-shaped recess 60. The additional C-shaped member 61 is provided with an arm 62 which extends away from the ball 31, perpendicularly to the arm 50 of the pivot mechanism 43 (shown in FIG. 10a). Attached to the arm 62 is a magnet 63, the magnet partially surrounding a Hall Effect sensor 64. The Hall Effect sensor 64 is fixed in position relative to the x-y plate 39 (shown in FIG. 7a) so that x-y movement of the x-y plate 39 does not affect the detection of banking movement of the magnet 63 (and thus the ball 31) by the Hall Effect sensor 64.

The additional C-shaped recess 60 is slightly longer than the additional C-shaped member 61 which sits inside the recess 60. Due to this difference in length, two spaces 60a are formed in the additional C-shaped recess 60 adjacent the ends of the additional C-shaped member 61. If the ball 31 is twisted, spaces 60a allow the additional C-shaped recess 60 to twist without impacting and thereby causing movement of the additional C-shaped member 61. Thus, twisting of the ball 31 does not move the additional C-shaped member 61, and does not therefore affect measurement of the degree of banking of the ball 31 by the Hall Effect sensor 64.

FIG. 12b shows that the cap 54 keeps the additional C-shaped member 61 in the additional C-shaped recess 60 when the ball 31 is banked.

As described above, the arm 55 attached to the ball 31 is attached to the shaft 56 of the second return to zero mechanism 45. In a similar manner to that described above, the ball 31 is returned to a zero (i.e. equilibrium) position when a force which has made the ball 31 bank is no longer applied.

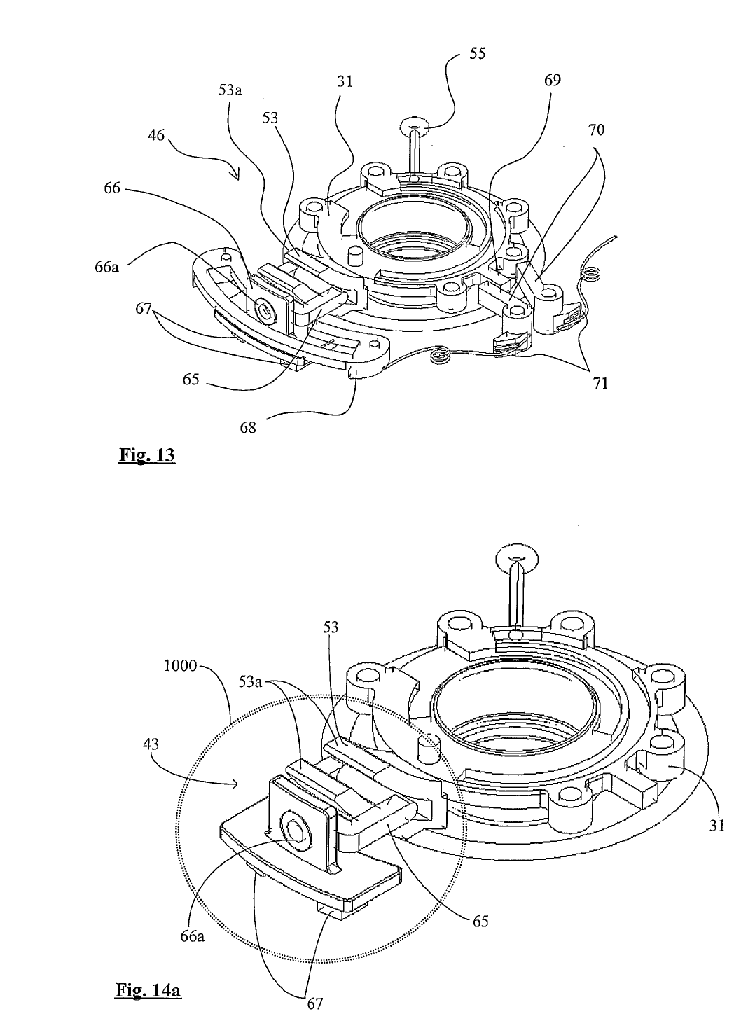

FIG. 13 illustrates the operation of the twist mechanism 46. As described above, the ball 31 is provided with a fork 53. The fork 53 extends away from the ball 31 and in the direction of the handle 30 (shown in FIG. 5a). The fork 53 therefore extends along the second imaginary axis, about which ball 31 banks. Slideably mounted between prongs 53a of the fork is a rectangular frame 65. The rectangular frame 65 is parallel to the x-y plate 39 (shown in FIG. 7a) and extends away from the centre of the ball 31. The rectangular frame 65 is also rotatably mounted in a magnet carrier 66. Specifically, the magnet carrier 66 is provided with a hole 66a into which the rectangular frame 65 extends, and about which the rectangular frame 65 may rotate. The magnet carrier 66 is provided with a magnet 67 which extends towards the base plate (shown in FIG. 7a).

The prongs 53a of the fork 53 fit snugly inside the rectangular frame 65. When the ball 31 is twisted, the rectangular frame 65 which is mounted in the fork 53 also twists. When the rectangular frame 65 twists, it causes the magnet carrier 66 to twist and also the magnet 67 which is attached to the magnet carrier 66. Twisting of the magnet 67 may be detected by a Hall Effect sensor (not shown) provided on the x-y plate 39, (shown in FIG. 7a), so that twisting of the handle 30 and therefore ball 31 may be detected.

The degree of rotation of the magnet carrier 66, as well as the degree of rotation of the ball 31, is limited by a curved frame 68 through which the magnet carrier 66 extends. Twist of the ball 31, and thus the magnet carrier 66, is restricted by the ends of the inside of the frame 68.

If the ball 31 is pivoted, the fork 53 still retains the rectangular frame 65 within its prongs 53a, and is able to slide relative to the rectangular frame 65. Thus, pivoting of the ball 31 does not affect the measurement of the degree of twist of the ball 31 by the magnet 67 and Hall Effects sensor (not shown).

If the ball 31 is banked, the fork 53 causes the rectangular frame 65 to bank in a similar fashion. However, banking of the rectangular frame 65 does not affect the orientation or position of the magnet carrier 66, since the rectangular frame 65 is rotatably mounted in the magnet carrier 66.

As described above, the ball 31 is attached to the second return to zero mechanism 45 by arm 55 which extends from the ball 31. In a similar manner to that described above in relation to the pivoting or banking of the ball 31, if the ball 31 is twisted, it may be returned to zero by the second return to zero mechanism 55. However, a third return to zero mechanism may be provided to ensure that the ball 31, when twisted, returns to its zero (i.e. equilibrium position).

It can be seen in FIG. 13 that the ball 31 is provided with a protrusion 69. Attached to the x-y plate 39 (shown in FIG. 7a) are two lever arms 70. The lever arms 70 are biased into contact with the protrusion 69 by springs 71. When the ball 31 is twisted, the protrusion 69 of the ball 31 pushes against one of the lever arms 70 which in turn pushes against one of the springs 71. One of the lever arms 70 shown in FIG. 13 is shown in a biased state for explanatory purposes only, i.e. in practice, both lever arms 70 will be in physical contact with the protrusion 69 when the ball 31 is not twisted. It can be seen that, when the ball 31 is twisted, the springs 71 bias the ball 31 back to its zero (i.e. equilibrium) position. The movement of the lever arms 70 may be restricted by stops on the x-y plate 33, which also serve to restrict the twist of the ball 31.

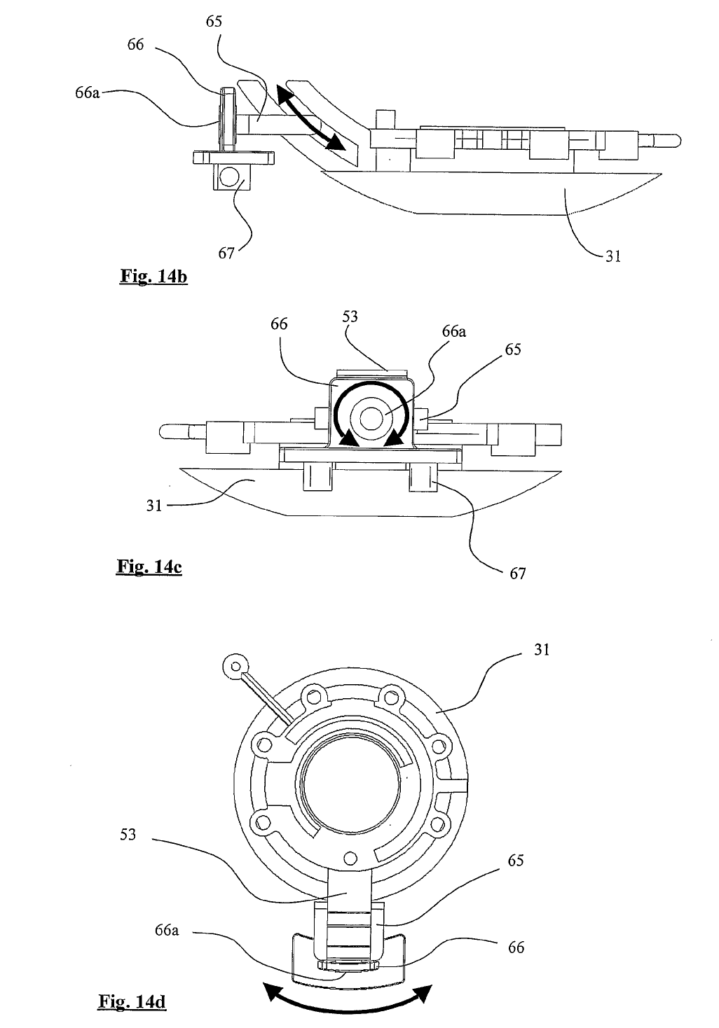

It can be seen from the description of the embodiment of FIGS. 5 to 13 that the mechanisms which allow the x-y plate 39 to move in the x-y plane, and for the ball 31 to pivot, bank and twist are complex. In previous computer input apparatus which have tried to realise multiple degrees of motion (i.e. x-y movement, bank, pivot and twist) it has been found to be difficult to incorporate mechanisms which allow the computer input apparatus to move in a plurality of axes either simultaneously, or without affecting the measurement of movement of the apparatus in another axis (i.e. independent movement). FIG. 14a shows a connecting mechanism of the computer input apparatus of the present invention which allows such multiple or independent movement to be realised. The large dashed circle 1000 highlights this connecting mechanism.

The connecting mechanism 1000 of the computer input apparatus has already been described in relation to the above Figures. There are three specific features of the connecting mechanism which allow the computer input apparatus to achieve simultaneous or independent movement. Firstly, the twist mechanism 43 is slideably attached to the ball 31 by way of the rectangular frame 65 (which is part of the twist mechanism 43) and the fork 53 (which is a part of the ball 31). The ball 31 may therefore be pivoted without affecting the measurement of twist of the ball 31. Indeed, the ball 31 can be twisted at the same time as it is being pivoted. Secondly, the prongs 53a of the fork 53 of the ball 31 fit snugly inside the rectangular frame 65, so that twist of the ball 31 directly affects twist of the magnet carrier 66 and magnet 67 attached thereto. Therefore, there is no lag between twist of the ball 31 and measurement of this twist by the magnet 67 and Hall Effect sensor. Thirdly, the rectangular frame 65 which is slideably mounted in the fork 53 is also pivotally mounted to the magnet carrier 66. Thus, if the ball 31 is banked, the orientation of the magnet carrier 66, and therefore the magnet 67, is not affected. Therefore, the ball may be simultaneously banked and pivoted, without affecting the measurement of twist of the ball 31.

FIG. 14b illustrates how the connecting mechanism allows the ball 31 to pivot without affecting orientation of the magnet carrier 66 and magnet 67. FIG. 14c illustrates how the ball 31 may be banked without affecting the orientation of the magnet carrier 66 or magnet 67. Finally, FIG. 14d illustrates twist of the ball 31, magnet carrier 66 and magnet 67.

It will be appreciated that the specific shape and orientation of the constituent parts of the mechanisms described above which allow the ball 31 to simultaneously bank, twist and pivot are not essential, and that other configurations and orientations may be suitable. For example, the fork 53 may not extend through the rectangular frame 65, but may extend around the rectangular frame 65, so long as the rectangular frame 65 is slideable in the fork 53. Similarly, the rectangular frame 65 need not be rotatably mounted to the magnet carrier 66, but could be rotatably mounted to the magnet 67 itself. Alternatively, the fork 53 could be rotatably mounted to the ball 31. The frame 65 may be any suitable shape. It will be appreciated that a fork 53 is not essential, and that any suitable guide may be used.

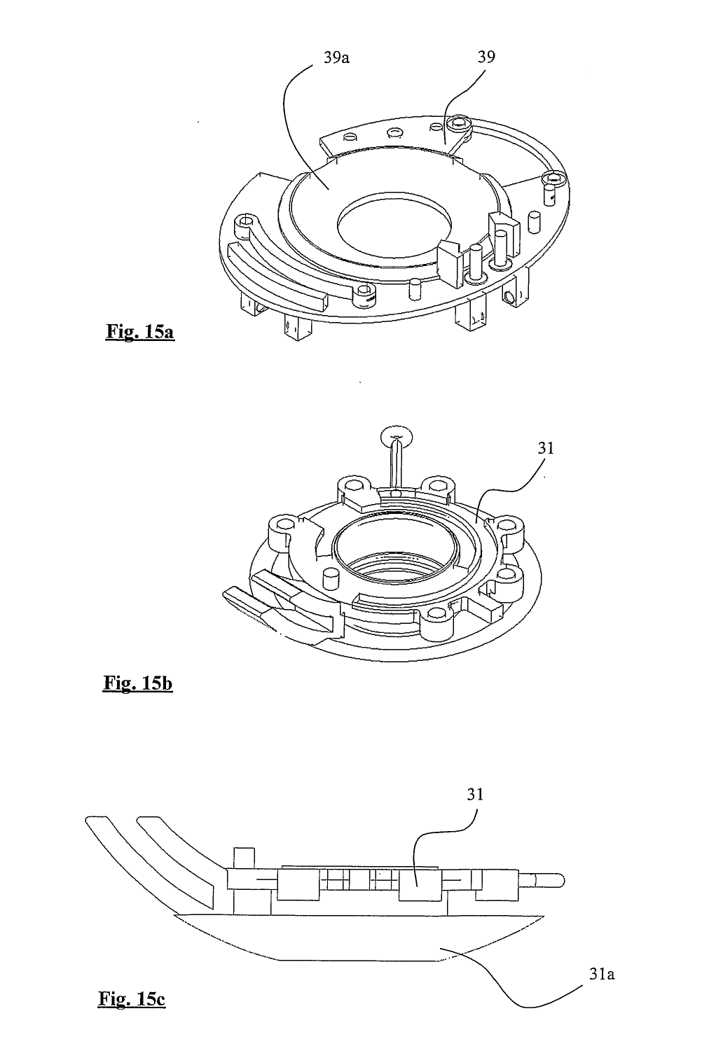

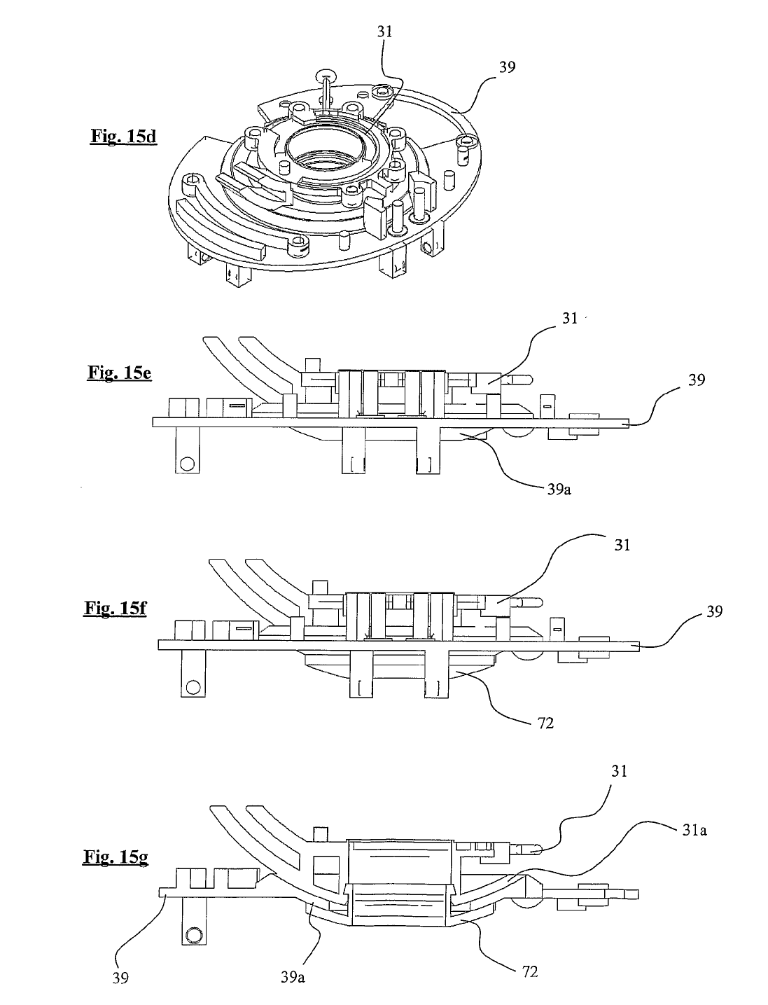

FIGS. 10, 11 and 12 have shown how the ball 31 may be pivoted, banked and twisted relative to the x-y plate 39. FIGS. 15a to 15g describe in more detail the ball and socket arrangement which allows the ball 31 to pivot, bank and twist relative to the x-y plate 39.

FIG. 15a shows the x-y plate 39 in perspective. It can be seen that the x-y plate 39 is provided with a concave section 39a about its centre. FIG. 15b illustrates the ball 31 in perspective. FIG. 15c illustrates a side view of the ball 31. It can be seen that the ball 31 is provided with a convex section 31a. The concave section 39a of the x-y plate 39 is shaped to receive the convex section 31a of the ball 31.

FIG. 15d illustrates the ball 31 when it is sitting in the concave section 39a of the x-y plate 39. FIG. 15e shows the ball 31 and x-y plate 39 in the side view. It can be seen that the ball 31 fits snugly into the concave section 39a of the x-y plate 39.

The ball 31 may be pivoted, twisted or banked when it is sitting in the concave section 39a of the x-y plate 39. Thus, a ball and socket arrangement is realised.

FIG. 15f illustrates how the ball 31 is secured to the x-y plate 39. FIG. 15f differs from FIG. 15e in that a clamp 72 is now shown. The primary purpose of the clamp 72 is to retain the ball 31 in the concave section 39a of the x-y plate 39. The clamp 72 may also be shaped to engage with features inside the ball 31 to restrict the banking and pivoting of the ball 31.

FIG. 15g illustrates FIG. 15f in cross section so that the interrelationship between the ball 31, clamp 72 and x-y plate 39 may be more easily seen and understood.

In the embodiments shown in and described with reference to FIGS. 5 to 15, magnets and Hall Effect sensors have been described as the apparatus used for detecting movement of the x-y plate 39 and ball 31. However, as with the embodiment of FIGS. 1 to 4, any suitable detection means may be used. For example, optical sensors (e.g. lasers and photodiodes), capacitive sensors, pressure sensors, electromagnetic sensors, gyroscopic sensors or galvanomagnetic sensors may be used.

In FIG. 5a, a socket section 32 was described. This socket section could be an extension of the x-y plate 39, or could be a structure which is attached to the x-y plate 39. The socket section 32 may be clipped onto the x-y plate 39 in such a way that the ball 31 and x-y plate 39 are clipped together and attached to the base, although still moveable relative to the base. For example, the socket section may clamp over the ball 31 and the x-y plate 39, the x-y plate 39 still remaining moveable relative to the base plate 33.

The handle 30 may be attached to the ball 31 in such a way that the distance between the middle of the ball 31 and middle of the handle 30 may be varied, e.g. to take account of the different sizes or preferences of users of the apparatus.

It will be understood that the term ‘wrist’ used herein may include the wrist of a user, and also regions of the users arm immediately adjacent the wrist, e.g. the lower part of a user's hand.

The computer input apparatus described above may be constructed in any suitable manner. For example, the apparatus may be constructed using suitable mouldings and fixings etc. Preferably, the constituent parts of the apparatus are made in such a way that assembly of the apparatus may be undertaken by snap fitting the constituent parts together. Such an assembly method may reduce assembly costs.

The computer input apparatus may be provided with suitable circuitry to allow movement of the ball 31 and x-y plate 39 to be detected and input to other hardware (e.g. a computer). Such circuitry and software used to process the inputs is well know, and will not be described here.

The terms ‘pivot’, ‘bank’ and ‘twist’ have been used to describe the computer input apparatus of FIGS. 5 to 15. It will be appreciated that these terms are commonly used when describing movement of an object in three-dimensional space. It will be appreciated that in describing the present invention, these terms have been used to describe rotation of the ball 31 in different directions (i.e. about different axis), and that the terms ‘pivot’, ‘bank’ and ‘twist’ have been used to give distinguish these different rotational directions. The terms' pivot', ‘bank’ and ‘twist’ are not intended to limit the rotation relatives to certain orientations of the apparatus (e.g. relative to the ground, etc.), but are intended to describe three orthogonal directions of rotation independent of the orientations of the apparatus.

It will be appreciated that the computer input apparatus described above may have a wide range of applications. Such applications may include the control of robots, vehicles, positioning systems, three-dimensional drawing packages and games.

It will be appreciated by one of ordinary skill in the art that the above-mentioned embodiments are given by way of example only. Various modifications may be made to these and other embodiments without detracting from the invention as defined by the claims, which follow

1. A computer input apparatus, comprising:
a base provided with a socket;
a ball segment located in the socket and rotatable in the socket, the ball segment being shaped to support a wrist of a user;
a handle attached to and extending away from the ball segment and configured such that when the user's wrist is supported by the ball segment, the handle is adjacent to the user's hand and maybe held by the user.

2. A computer input apparatus, comprising:
a base, the base being provided with a socket;
a ball segment located in the socket and rotatable in the socket, the ball segment being pivotable about a first axis, bankable about a second axis orthogonal to the first axis, and twistable about a third axis orthogonal to the first and second axis;
and
a twist detection mechanism for measuring twist of the ball about the third axis, the twist detection mechanism comprising a detector and a detectable element moveable relative to each another, one of the detector and the detectable element being slideably and rotatably connected to the ball segment, such that pivoting of the ball segment about the first axis or banking of the ball segment about the second axis does not affect the position of the detector or the detectable element, and such that twisting of the ball about the third axis does affect the position of one of the detector and the detectable element.

3. The computer input apparatus as claimed in claim 2, wherein the ball segment is provided with a guide, one of the detector and the detectable element being slideably connected to the ball via the guide.

4. The computer input apparatus as claimed in claim 3, wherein the guide comprises two prongs of a fork.

5. The computer input apparatus as claimed in claim 4, wherein one of the detector and the detectable element is slideably connected to the fork by a frame.

6. The computer input apparatus as claimed in claim 5, wherein a part of the frame extends between the prongs of the fork.

7. The computer input apparatus as claimed in claim 5 wherein a carrier is attached to the frame.

8. The computer input apparatus as claimed in claim 7, wherein the carrier is rotatably attached to the frame.

9. The computer input apparatus as claimed in claim 7 wherein the detectable element is attached to the carrier.

10. The computer input apparatus as claimed in claim 9, wherein the detector is fixed in position relative to the socket.

11. The computer input apparatus as claimed in claim 7 wherein the detector is attached to the carrier.

12. The computer input apparatus as claimed in claim 11, wherein the detectable element is fixed in position relative to the socket.

13. The computer input apparatus as claimed in claim 2, wherein the detector is a Hall Effect sensor and the detectable element is a magnet.

14. The computer input apparatus as claimed in claim 13, wherein the magnet is moveable relative to the Hall Effect sensor, and is slideably and rotatably connected to the ball segment.

15. The computer input apparatus as claimed in claim 13, wherein the Hall Effect sensor is moveable relative to the magnet, and is slideably and rotatably connected to the ball segment.

16. The computer input apparatus as claimed in claim 2, wherein the ball segment is shaped to support a wrist of a user.

17. The computer input apparatus as claimed in claim 16, wherein the ball segment is provided with a handle attached to and extending away from the ball segment and configured such that when the user's wrist is supported by the ball segment, the handle is adjacent to the user's hand and maybe held by the user.

18. The computer input apparatus as claimed in claim 1 wherein the distance between the ball and the handle is variable.

19. The computer input apparatus as claimed in claim 1 wherein the socket is moveable relative to the base.

20. The computer input apparatus as claimed in claim 19, wherein the base comprises a planar base plate, and the socket is moveable in a plane substantially parallel to the planar base plate.

21. The computer input apparatus as claimed in claim 1 wherein the socket is formed in a section of a plate.

22. The computer input apparatus as claimed in claim 1 wherein the ball segment is substantially hemispherical in shape.

23. The computer input apparatus as claimed in claim 1 wherein the ball segment forms a concave surface for receiving the wrist of a user.

24. The computer input apparatus as claimed in claim 1 wherein the ball segment is provided with a cushioning element.

25. The computer input apparatus as claimed in claim 24, wherein the cushioning element is a gel pad.

26. A computer input apparatus comprising:
a casing, the casing being connected to, and moveable relative to a base;
a post, attached to the casing, which extends towards the base; and
a return to zero mechanism for returning the position of the post and the casing to an equilibrium position when no pressure is applied to the casing, wherein the return to zero mechanism comprises:
a support structure defining an aperture through which the post extends; and
a plurality of arms pivotably attached to the support structure, the plurality of arms extending into the aperture and being biased toward the centre of the aperture, the plurality of arms being arranged to return the position of the post, and casing to which it is attached, to a zero position.

27. The computer input apparatus of claim 26, wherein adjacent arms extend into the aperture at different heights.

28. The computer input apparatus of claim 26 wherein the plurality of arms are substantially straight.

29. The computer input apparatus of claim 27, wherein the apparatus comprises at least a pair of arms, each arm of the pair being attached to an opposite side of the support structure.

30. The computer input apparatus of claim 28 wherein the apparatus comprises four pairs of arms.

31. The computer input apparatus of claim 26 wherein the at least one arm is provided with an outer stop, arranged to restrict movement of the arm towards the centre of the aperture.

32. The computer input apparatus of claim 26 wherein the at least one arm is provided with an inner stop, arranged to restrict movement of the arm away from the centre of the aperture.

33. The computer input apparatus of claim 26 wherein the support structure is a ring.

34. The computer input apparatus of any claim 26 wherein the at least one arm is biased by an O-ring.

35. A computer input apparatus comprising:
a casing, the casing being connected to, and moveable relative to a base; and
an anti-twist device for preventing twist of the casing relative to the base; wherein the apparatus further comprises a clutch mechanism, comprising:
a first surface;
a second surface; and
a biasing member arranged to bias the first surface away from contact with the second surface when no pressure is applied to the first surface;
wherein the clutch mechanism is arranged such that, when sufficient pressure is applied to the first surface to overcome the biasing member, the first surface contacts the second surface and disengages the anti-twist device, thereby allowing twist of the casing relative to the base.

36. The computer input apparatus of claim 35, wherein the anti-twist device is located between the casing and the base.

37. The computer input apparatus of claim 35 wherein the apparatus further comprises a twist plate connected to, and twistable relative to the base plate, and wherein the anti-twist device is attached to the casing and to the twist plate.

38. The computer input apparatus of claim 37, wherein the anti-twist device is pivotably attached to the casing and the twist plate.

39. The computer input apparatus of claim 35 wherein the anti-twist device is a pantograph.

40. The computer input apparatus of claim 36 wherein a surface of the twist plate forms the second surface.

41. The computer input apparatus of claim 35 wherein the first surface is attached to the casing.

42. The computer input apparatus of claim 35 wherein at least one of the first surface and the second surface has a high coefficient of friction.

43. The computer input apparatus of claim 35 wherein at least one of the first surface and the second surface is annular.

44. The computer input apparatus of claim 35 wherein the biasing member is disposed between the first surface and second surface.

45. The computer input apparatus of claim 35 wherein the biasing member is one of a group comprising: a wavy washer and a coil spring.

46. The computer input apparatus of claim 35 wherein at least one of the first surface and the second surface comprises a recess.

47. The computer input apparatus of claim 46, wherein the recess is annular.

48. The computer input apparatus of claim 46 or claim 47, wherein the biasing member is located in the recess, and arranged to protrude from the recess when in an uncompressed state.

49. (canceled)
